(19) United States
(12) Patent Application Publication
(10) Pub. No.: US 2018/0232326 A1
(43) Pub. Date: Aug. 16, 2018

(54) REAL-TIME PROCESSING SYSTEM FOR INFORMATION UNIT SET, AND METHOD THEREFOR

(71) Applicant: Fan Wu, Beijing (CN)

(72) Inventor: Fan Wu, Beijing (CN)

(21) Appl. No.: 15/516,459

(22) PCT Filed: Jun. 30, 2015
(86) PCT No.: PCT/CN2015/082949

§ 371 Date: Apr. 3, 2017

(30) Foreign Application Priority Data
Feb. 13, 2015 (CN) 201510079317.3

(51) Int. Cl. G06F 13/16; G06F 3/06

(52) U.S. Cl. CPC G06F 13/1668; G06F 3/0673; G06F 3/0647; G06F 3/0604

(57) ABSTRACT

The present invention relates to a real-time processing system for an information unit set, comprising: a control operation unit, a time source unit and a user information unit set; wherein the time source unit is configured to provide time for the control operation unit; the time source unit is further configured to provide a heartbeat signal for each user's information unit set; said each user's information unit set comprises: a data input port, a data output port, a heartbeat line control switch and an information unit; each set of information unit in the user's information unit set further comprises: a steady-state storage module, a data output control switch of the steady-state storage module, an association exciter, a dynamic storage module and a data output control switch of the dynamic storage module.

### FIELD OF THE INVENTION

The present invention relates to the technical field of information service computation, and particularly to a real-time processing system and real-time processing method for an information unit set.

### BACKGROUND OF THE INVENTION

As science and technology develops nowadays, high-speed development of fields such as the Internet and communications provides various convenience to people's life. As international integration process quickens and fiscal and financial industry develops rapidly, people's financing awareness becomes stronger and stronger. With rapid development of technologies in the Internet financial field, network banks and personal financing and the like urge consecutive development of relevant financial and fiscal management application systems or software.

Current systems and methods involved by application technologies in the field of Internet financing cannot satisfy the user's requirements to master various dynamic information of the user's accounts in real time. The current financial and fiscal management software systems only provide an interface for accessing an information database and a human-machine interface for the user to operate, and read/write financial data according to the user's operation. Furthermore, along with development of the Internet financial technologies, financing services enabling quick cash withdrawal begin to be universally applied to mobile phone APP. Hence, according to the foregoing description, people increasingly call for a technology of effectively combining financial and Internet technologies, which therefore may not only satisfy the user's interest claims to better attract the client's funds but also make it increasingly desirable to improve a management control level of for example an Internet financial management company through technologies.

### SUMMARY OF THE INVENTION

The present invention is intended to solve the above problems, meanwhile enable the user to operate data in a user information unit through an Internet terminal or communication terminal at any time, perform management according to dynamic information provided by a computing system, and solve a problem in the prior art about failure to visually display time and proportion change relationship between dynamic information and failure to operate according to definite dynamic information in real time. The present invention provides a real-time processing system and real-time processing method for an information unit set.

By providing a real-time processing system and real-time processing method for an information unit set, the present invention implements a data amount-integrated real-time dynamic calculation and information storage service. In the system, the user may file a data input request and a data output request for the information unit set at any time through an Internet terminal or mobile communication terminal.

The present application provides a real-time processing system for an information unit set, comprising: a control operation unit, a time source unit and a user information unit set; wherein,

the control operation unit creates a user information unit set for each registered user upon registration; the control operation unit is further configured to implement data accumulation, data comparison, and a data difference after data comparison;

the time source unit is configured to provide time for the control operation unit; the time source unit is further configured to provide a periodic heartbeat signal for each user's information unit set;

said each user's information unit set comprises: a data input port, a data output port, a heartbeat line control switch and an information unit; wherein, when the user's information unit set is created, if there is not any input data in the set, the number of information units in the set is 0; when there is input data for the first time in the set, the control operation unit creates the first information unit in the set; in the same way, when there is input data for the n^{th} time in the set, the control operation unit creates the n^{th} information unit in the set;

each set of information unit in the user's information unit set further comprises:

a steady-state storage module: connected to the control operation unit via a control line to perform a control operation of the control operation unit; connected to the data input port through a data line to store data amount input by the user information unit set; connected with a data output control switch of the steady-state storage module through a data line so that when the switch is closed, the steady-state storage module may output data amount to the data output port; connected with an association exciter through an excitation line to provide an excitation base for the association exciter;

the association exciter: connected with the steady-state storage module through an excitation line to receive excitation of data amount in the steady-state storage module; connected with the time source unit through a heartbeat line to receive a heartbeat signal from the time source unit; at the time of receiving the heartbeat signal each time, the association exciter generates a new data amount for one time under excitation of the data amount in the steady-state storage module; the new data amount generated at this time is: a product of the three parameters: the data amount in the steady-state storage module at this time, an excitation rate in the association exciter at this time and a time length of a heartbeat signal cycle; furthermore, once the association exciter receives at least one heartbeat signal, the excitation rate in the association exciter changes; the association exciter is connected with a dynamic storage module via a data line, and the new data amount generated in the association exciter each time is output to the dynamic storage module;

the dynamic storage module: connected with the control operation unit through a control line to perform control operation of the control operation unit; connected with the association exciter through a data line to store the new data amount generated in the association exciter each time; connected with a data output control switch of the dynamic storage module through a data line so that the dynamic storage module may output data amount to the data output port when the switch is closed;

the data output control switch of the steady-state storage module: connected with the steady-state storage module and the data output port respectively through a data line; when the switch is closed, the steady-state storage module may output data amount to the data output port; when the switch is opened, the steady-state storage module cannot output data amount to the data output port;

the data output control switch of the dynamic storage module: connected with the dynamic storage module and the data output port respectively through a data line; when the switch is closed, the dynamic storage module may output data amount to the data output port; when the switch is opened, the dynamic storage module cannot output data amount to the data output port.

A real-time processing method for an information unit set, wherein the real-time system for the information unit set involved in the method comprises: a control operation unit, a time source unit and a user information unit set; the method comprises a data input flow of the information unit set and a data output flow of the information unit set; wherein the data input flow of the information unit set comprises:

upon receiving a data input request to the user's information unit set, the control operation unit performs the following operations:

R1) The control operation unit checks the data input request; if the check fails, rejects the data input request of this time and returns corresponding cause information; if the check passes, continues to perform the following operations;

R2) The control operation unit reads current time information T from the time source unit and records it;

R3) The control operation unit adds 1 to the number n of times of the user's data input operations;

Wherein the number of times of the user's data input operations is designated by n, and n=0, 1, 2, . . . , natural number;

Time of the user's data input operation of the n^{th} time Tu(n)=T, and n=1, 2, 3, . . . ;

Wherein time of creating the user's information unit set is represented by Tu(0);

R4) The control operation unit creates a new information unit, namely, the n^{th} information unit, in the user's information unit set;

Wherein time Tn(0) of creating the user's n^{th} information unit is the previously-recited time T, namely, Tn(0)=Tu(n)=T, and n=1, 2, 3 . . . ;

The user's n^{th} information unit contains:

Module 1: a steady-state storage module which stores data amount Cn;

An initial value of Cn upon the creation time Tn(0) is input data amount Lu of the data input request of this time received by the user from the data input port at time T, and expressed as Cn(Tn(0))=Lu(T);

Module 2: an association exciter,

i(Tn(0)) as an initial excitation rate of the association exciter at the creation time Tn(0) is represented by in(0); the excitation rate after it receives the first heartbeat signal is represented as in(1), in(0)=in(1) or in(0)<in(1); the excitation rate after it receives the second heartbeat signal is represented as in(2), and in(1)=in(2) or in(1)<in(2); similarly, the excitation rate after it receives the g^{th} heartbeat signal is represented as in(g), and in(g−1)=in(g) or in(g−1)<in(g); the excitation rate after it receives the g+1^{th} heartbeat signal is represented as in(g+1), and in(g)=in(g+1) or in(g)<in(g+1);

So long as the data amount in the steady-state storage module is not equal to zero, as time shifts, the time T_{HB} when the association exciter receives the heartbeat signal each time generates a new data amount δEn one time under excitation of the data amount Cn(T_{HB}) in the steady-state storage module:

δEn=Cn(T_{HB})*in(g)*δT=δEn(g);

wherein δT is a time length of a cycle of the time source unit sending the heartbeat signal; T_{HB} is time when the association exciter receives the heartbeat signal, T_{HB}=T₁+(g−1)*δT=T_{g}, namely, T_{HB} is also time of the time source unit sending the g^{th} heartbeat signal since the time of creating the n^{th} information unit; T₁ is time of the time source unit sending the first heartbeat signal since the time of creating the n^{th} information unit; Cn(T_{HB}) is the data amount of the steady-state storage module of the user's n^{th} information unit at the time T_{HB}; in(g) is the excitation rate when the number of the heartbeat signals received by the association exciter reaches g;

Module 3: a dynamic storage module which stores data amount En;

As an initial value of En at the creation time Tn(0), En(Tn(0))=0;

Then so long as the data amount in the steady-state storage module is not equal to zero, as time shifts, after the association exciter receives the heartbeat signal each time, the association exciter outputs new data amount δEn(g) once to the dynamic storage module; at the time t, the data amount accumulatively input by the user's n^{th} information unit from the association exciter is represented by SigEn(t);

Module 4: a data output control switch of the steady-state storage module, represented as SCn;

When SCn in the user's n^{th} information unit is in an opened state, data in the steady-state storage module of the n^{th} information unit cannot be output, and the data amount in the steady-state storage module will not reduce; when SCn is in a closed state, the data in the steady-state storage module may be output;

Module 5: a data output control switch of the dynamic storage module, represented as SEn;

When SEn in the user's n^{th} information unit is in an opened state, data in the dynamic storage module of the n^{th} information unit cannot be output, and the data amount in the dynamic storage module will not reduce; when SEn is in a closed state, the data in the dynamic storage module may be output.

The present invention has the following advantages:

1) Establish an information unit set for each user. Each information unit set is a 2-dimensional structure comprised of a longitudinal direction and a transverse direction. Longitudinal storage units are built in turn according to the user's behaviors of sequentially inputting data amount. The system records the time of the user inputting the data amount as an index of the storage unit. Each storage unit is divided into a steady-state storage module and a dynamic storage module in the transverse direction, wherein the data amount in the steady-state storage module, with an excitation rate in(t), excites the dynamic storage module to generate a new data amount. The excitation rate in(t) constantly increases as the time t shifts.

2) When the user outputs data amount each time, the system operates the information unit set according to a unique rule. The rule is: first, output data amount from the dynamic storage module, and then select the steady-state storage module in a reverse order of creation time and output data amount therein. The order is as follows: data amount of the dynamic storage module→data amount in the steady-state storage module created the latest→data amount in the steady-state storage module created the second latest→ . . . .

3) The rule is intended to pursue for maximum of a total value of the data amount in the whole information unit set. In the user's information unit set, as for those information units with the data amount not being zero, the association exciter in the information unit created earlier has a larger excitation rate.

### BRIEF DESCRIPTION OF DRAWINGS

FIG. 1 is a system structural diagram of an information unit set according to the present invention.

FIG. 2 is an overall structural diagram of the user's information unit set and connectional relationship between it and a control operation unit and a time source unit according to the present invention.

FIG. 3 is a structural diagram of the user's n^{th} information unit according to the present invention.

FIG. 4 is a schematic diagram showing that different sub-accounts need to be established for data input operations at different time in an embodiment of the present invention.

FIG. 5 is a schematic diagram showing historical operations are recorded in each sub-account in an embodiment of the present invention.

### DETAILED DESCRIPTION OF PREFERRED EMBODIMENTS

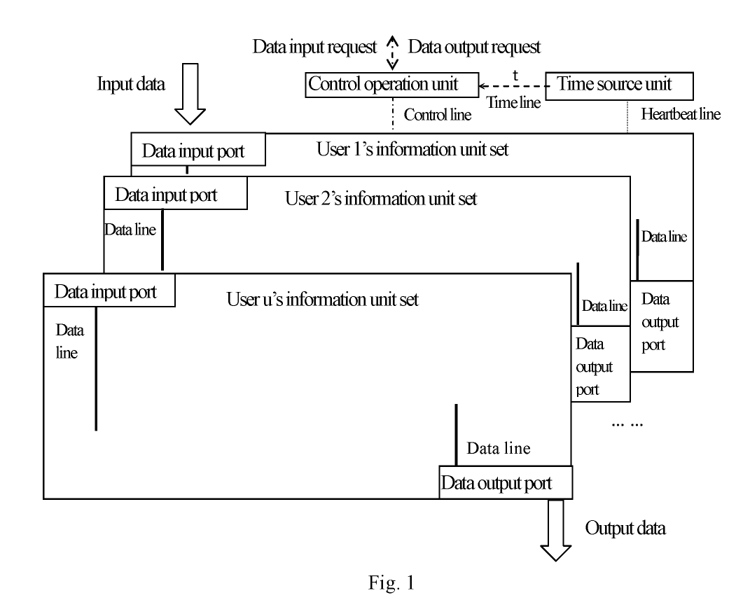

In an embodiment of the present invention involving a system, an overall structure of the system is as shown in FIG. 1. The present embodiment specifically relates to a real-time processing system for an information unit set, comprising a control operation unit, a time source unit and a user information unit set; wherein,

The control operation unit creates a user information unit set for each registered user upon registration; the control operation unit is further configured to implement data accumulation, data comparison, and a data difference after data comparison;

The time source unit is configured to provide time for the control operation unit; the time source unit is further configured to provide a periodic heat beat signal for each user's information unit set;

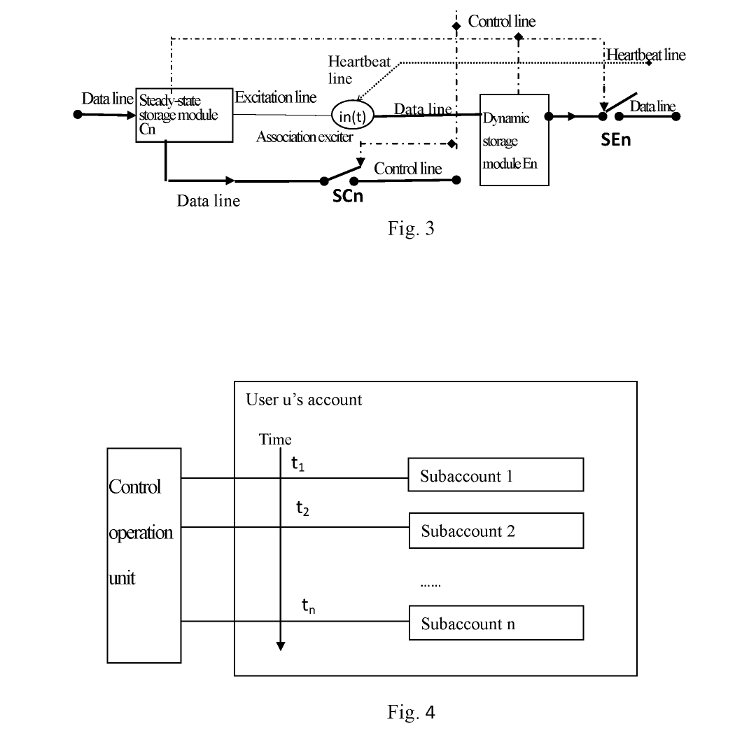

Said each user's information unit set comprises: a data input port, a data output port, a heartbeat line control switch and an information unit; wherein, when the user's information unit set is created, if there is not any input data in the set, the number of information units in the set is 0; when there is input data for the first time in the set, the control operation unit creates the first information unit in the set; in the same way, when there is input data for the n^{th} time in the set, the control operation unit creates the n^{th} information unit in the set, as shown in FIG. 3.

Each set of information unit in the user's information unit set further comprises: a steady-state storage module: connected to the control operation unit via a control line to perform a control operation of the control operation unit; connected to the data input port through a data line to store data amount input by the user information unit set; connected with a data output control switch of the steady-state storage module through a data line so that when the switch is closed, the steady-state storage module may output data amount to the data output port; connected with an association exciter through an excitation line to provide an excitation base for the association exciter;

the association exciter: connected with the steady-state storage module through an excitation line to receive excitation of data amount in the steady-state storage module; connected with the time source unit through a heartbeat line to receive a heartbeat signal from the time source unit; at the time of receiving the heartbeat signal each time, the association exciter generates a new data amount for one time under excitation of the data amount in the steady-state storage module; the new data amount generated at this time is: a product of the three parameters: the data amount in the steady-state storage module at this time, an excitation rate in the association exciter at this time and a time length of a heartbeat signal cycle; furthermore, once the association exciter receives at least one heartbeat signal, the excitation rate in the association exciter changes; the association exciter is connected with a dynamic storage module via a data line, and the new data amount generated in the association exciter each time is output to the dynamic storage module;

The dynamic storage module: connected with the control operation unit through a control line to perform control operation of the control operation unit; connected with the association exciter through a data line to store the new data amount generated in the association exciter each time; connected with the data output control switch of the dynamic storage module through a data line so that the dynamic storage module may output data amount to the data output port when the switch is closed;

The data output control switch of the steady-state storage module: connected with the steady-state storage module and the data output port respectively through a data line; when the switch is closed, the steady-state storage module may output data amount to the data output port; when the switch is opened, the steady-state storage module cannot output data amount to the data output port;

The data output control switch of the dynamic storage module: connected with the dynamic storage module and the data output port respectively through a data line; when the switch is closed, the dynamic storage module may output data amount to the data output port; when the switch is opened, the dynamic storage module cannot output data amount to the data output port.

The data output port is connected, via a data line, with the data output control switch of each steady-state storage module and the data output control switch of each dynamic storage module in the information unit set; when the switches are closed, data amount received by the data output port from the corresponding storage module connected by the data output control switch is accumulated and stored;

The data output port is connected with the control operation unit via a control line, and performs a data amount output operation according to an operation instruction of the control operation unit.

Each user's information unit set further comprises a heartbeat count register; the heartbeat count register is connected with the time source unit via a heartbeat line and receives a heartbeat signal from the time source unit; the heartbeat count register is connected with a heartbeat line control switch via a heartbeat line; while the heartbeat line control switch is opened, the heartbeat count register records the number h of received heartbeat signals; at the time when the first heartbeat signal comes after the heartbeat line control switch is closed again, the heartbeat count register broadcasts and sends the heartbeat signal to all exciter in the user's information unit set, and a value of a heartbeat number field in the heartbeat signal is h+1, wherein h is the number of heartbeat signals recorded by the heartbeat count register during the opening of the heartbeat line control switch, h=0, 1, 2 . . . ;

The time source unit is capable of providing the heartbeat signal to each user's information unit set, and a time length of a time period δT of the heartbeat signal is 1 second, or 2 seconds, or 3 seconds, or 4 seconds, or 5 seconds, or 6 seconds, or 10 seconds, or 12 seconds, or 15 seconds, or 20 seconds, or 30 seconds or 60 seconds.

Once the association exciter receives at least one heartbeat signal, an excitation rate of the association exciter increases constantly; in the user's information unit set, as for those information units with the data amount not being zero, the association exciter in the information unit created earlier in the set has a larger excitation rate.

An initial state of the heartbeat line control switch upon creation in each user's information unit set is closed.

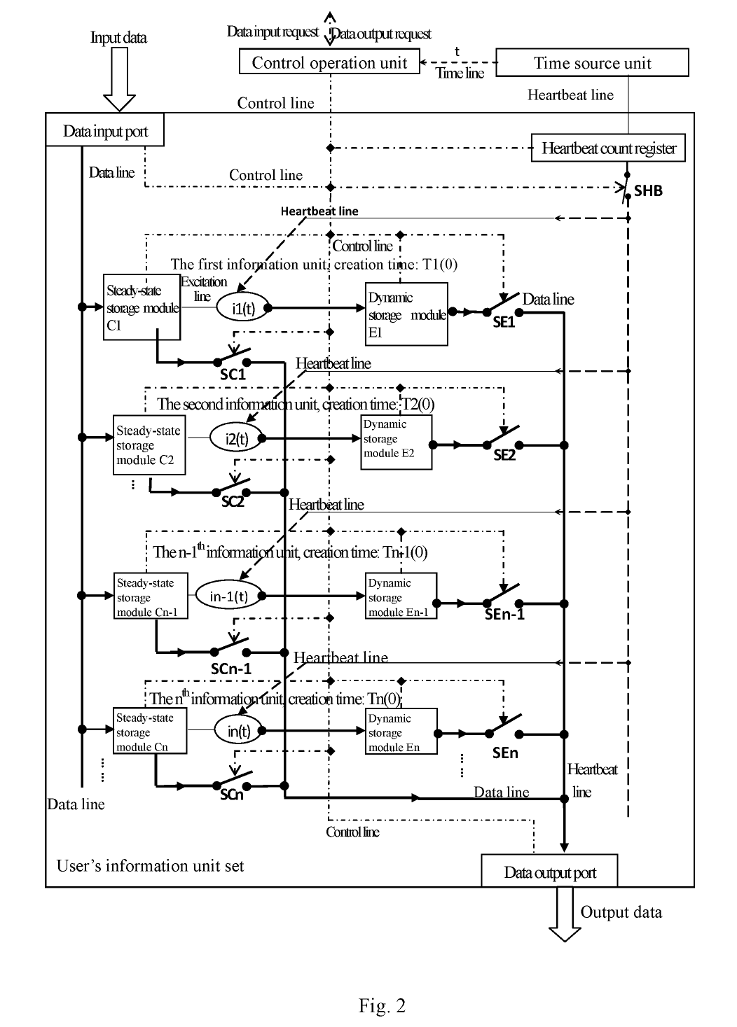

In conjunction with FIG. 2, the present application provides a real-time processing method for an information unit set, wherein the real-time system for the information unit set involved in the method comprises: a control operation unit, a time source unit and a user information unit set; the method comprises a data input flow of the information unit set and a data output flow of the information unit set; wherein the data input flow of the information unit set comprises:

Upon receiving a data input request to the user u's information unit set, the control operation unit performs the following operations:

R1) The control operation unit checks the data input request; if the check fails, rejects the data input request of this time and returns corresponding cause information; if the check passes, continues to perform the following operations;

R2) The control operation unit reads current time information T from the time source unit and records it;

R3) The control operation unit adds 1 to the number n of times of the user u's data input operations; Wherein the number of times of the user u's data input operations is designated by n, and n=0, 1, 2, . . . , natural number;

Time of the user u's data input operation of the n^{th} time Tu(n)=T, and n=1, 2, 3, . . . ;

Wherein time of creating the user u's information unit set is represented by Tu(0);

R4) The control operation unit creates a new information unit, namely, the n^{th} information unit, in the user u's information unit set;

Wherein time Tn(0) of creating the user u's n^{th} information unit is the previously-recited time T, namely, Tn(0)=Tu(n)=T, and n=1, 2, 3 . . . ;

The user u's n^{th} information unit contains:

Module 1: a steady-state storage module which stores data amount Cn;

An initial value of Cn upon the creation time Tn(0) is input data amount Lu of the data input request of this time received by the user u from the data input port at time T, and expressed as Cn(Tn(0))=Lu(T);

Module 2: an association exciter,

i(Tn(0)) as an initial excitation rate of the association exciter at the creation time Tn(0) is represented by in(0); the excitation rate after it receives the first heartbeat signal is represented as in(1), in(0)=in(1) or in(0)<in(1); the excitation rate after it receives the second heartbeat signal is represented as in(2), and in(1)=in(2) or in(1)<in(2); similarly, the excitation rate after it receives the g^{th} heartbeat signal is represented as in(g), and in(g−1)=in(g) or in(g−1)<in(g); the excitation rate after it receives the g+1^{th} heartbeat signal is represented as in(g+1), and in(g)=in(g+1) or in(g)<in(g+1);

So long as the data amount in the steady-state storage module is not equal to zero, as time shifts, the time T_{HB} when the association exciter receives the heartbeat signal each time generates a new data amount δEn one time under excitation of the data amount Cn(T_{HB}) in the steady-state storage module:

δEn=Cn(T_{HB})*in(g)*δT=δEn(g);

wherein δT is a time length of a cycle of the time source unit sending the heartbeat signal; T_{HB} is time when the association exciter receives the heartbeat signal, T_{HB}=T₁+(g−1)*δT=T_{g}, namely, T_{HB} is also time of the time source unit sending the g^{th} heartbeat signal since the time of creating the n^{th} information unit; T₁ is time of the time source unit sending the first heartbeat signal since the time of creating the n^{th} information unit; Cn(T_{HB}) is the data amount of the steady-state storage module of the user u's n^{th} information unit at the time T_{HB}; in(g) is the excitation rate when the number of the heartbeat signals received by the association exciter reaches g;

Module 3: a dynamic storage module which stores data amount En;

As an initial value of En at the creation time Tn(0), En(Tn(0))=0;

Then so long as the data amount in the steady-state storage module is not equal to zero, as time shifts, after the association exciter receives the heartbeat signal each time, the association exciter outputs new data amount δEn(g) once to the dynamic storage module; at the time t, the data amount accumulatively input by the user u's n^{th} information unit from the association exciter is represented by SigEn(t);

Module 4: a data output control switch of the steady-state storage module, represented as SCn;

When SCn in the user u's n^{th} information unit is in an opened state, data in the steady-state storage module of the n^{th} information unit cannot be output, and the data amount in the steady-state storage module will not reduce; when SCn is in a closed state, the data in the steady-state storage module may be output; Module 5: a data output control switch of the dynamic storage module, represented as SEn;

When SEn in the user u's n^{th} information unit is in an opened state, data in the dynamic storage module of the n^{th} information unit cannot be output, and the data amount in the dynamic storage module will not reduce; when SEn is in a closed state, the data in the dynamic storage module may be output.

At the time T_{HB} when the association exciter receives the heartbeat signal, new data amount δEn generated by the association exciter under the excitation of the data amount Cn(T_{HB}) in the steady-state storage module may further be as follows:

If a heartbeat number field value in the heartbeat signal received by the association exciter in the user u's n^{th} information unit at the time THB is h+1, and h=0, 1, 2, . . . ; the new data amount δ En generated by the association exciter at this time is:

δEn=Cn(T_{HB})*(in(g+1)+ . . . +in(g+h)+in(g+h+1))*δT=Cn(T₁+(g+h)*δT)*(in(g+1)+ . . . +in(g+h)+in(g+h+1))*δT=δEn(g+h+1);

Wherein the current time T_{HB}=T₁+(g+h)*δT=T_{g}+(h+1)*δT=T_{g+h+1},

δT is a time length of a cycle of the time source time sending the heartbeat signal;

T₁ is time of the time source unit sending the first heartbeat signal since the time of creating the n^{th} information unit;

T_{g} is time of the time source unit sending the g^{th} heartbeat signal since the time of creating the n^{th} information unit, T_{g}=T₁+(g−1)*δT; T_{g} is simultaneously the time of the association exciter receiving the heartbeat signal for the latest time before the current time T_{HB};

Cn(T_{HB}) is data amount of the steady-state storage module of the user u's n^{th} information unit at the current time T_{HB}, Cn(T_{HB})=Cn(t1+(g+h)*δT)=Cn(T_{g+h+1});

in(g+1) is an excitation rate when the number of the heartbeat signals received by the association exciter reaches g+1;

in(g+2) is an excitation rate when the number of the heartbeat signals received by the association exciter reaches g+2;

Similarly,

in(g+h) is an excitation rate when the number of the heartbeat signals received by the association exciter reaches g+h;

in(g+h+1) is an excitation rate when the number of the heartbeat signals received by the association exciter reaches g+h+1;

at the time t, the data amount SigEn(t) accumulatively input by the user u's n^{th} information unit from the association exciter is as follows:

At and after the creation time Tn(0) of the association exciter and prior to the time T₁ of receiving the heartbeat signal for the first time, namely, when t∈[Tn(0), T1), SigEn(t)=0; wherein T₁ ∈[Tn(0), Tn(0)+ST), and δT is a time length of a cycle of the time source time sending the heartbeat signal;

At and after the time T₁ of the association exciter receiving the heartbeat signal for the first time and prior to time T₂ of receiving the heartbeat signal for the second time, namely, when t∈[T₁, T₂), SigEn(t)=δEn(1); wherein δEn(1) is the new data amount generated when the association exciter receives the heartbeat signal for the first time;

At and after the time T₂ of the association exciter receiving the heartbeat signal for the second time and prior to time T₃ of receiving the heartbeat signal for the third time, namely, when t∈[T₂, T₃), SigEn(t)=δEn(1)+δEn(2); wherein δEn(2) is the new data amount generated when the association exciter receives the heartbeat signal for the second time;

Similarly,

At and after the time Tⱼ of the association exciter receiving the heartbeat signal for the j^{th} time and prior to time Tⱼ₊₁ of receiving the heartbeat signal for the j+1^{th} time, namely, when t∈[Tₐ, T₁₊₁), SigEn(t)=δEn(1)+δEn(2)+ . . . +δEn(j); wherein δEn(j) is the new data amount generated when the association exciter receives the heartbeat signal for the j^{th} time.

The data output flow of the information unit set comprises: The control operation unit receives, at the time T, a data output request with respect to the user u's information unit set. When a request value is P(T), the following operations are performed:

1) The control operation unit checks the data output request; if the check fails, rejects the data output request of this time and returns corresponding cause information;

if the check passes, continues to perform the following operations:

2) The control operation unit reads current time information T from the time source unit and records it;

The time T here is system-recorded time of the control operation unit of receiving the data output request with respect to the user u's information unit set, as well as system-recorded time of the control operation unit of operating data output with respect to the user u's information unit set;

3) The control operation unit opens the user u's heartbeat line control switch SHB;

4) The control operation unit adds 1 to a record of the number of times of data output operations with respect to the user u's information unit set; wherein the number of times of data output operations with respect to the user u's information unit set is represented by b, and b=0, 1, 2, . . . natural number;

And, the control operation unit records time Tuo(b) of the b^{th} data output operation with respect to the user u's information unit set, and Tuo(b)=T, wherein b=1, 2, 3, . . . ; that is, the system-recorded time T of the control operation unit of operating data output with respect to the user u's information unit set as stated in the above step 2) is also the system-recorded time of the b^{th} data output operation with respect to the user u's information unit set;

5) Compare P(T) with Su(T), Su(T)=Cu(T)+Eu(T); and process the data output request according to the comparison result; wherein Cu(T) is a sum of data amount of the steady-state storage module in the user u's information unit set at the time T, and Cu(T)=C0(T)+C1(T)+ . . . +Cn(T); Eu(T) is a sum of data amount of the dynamic storage module in the user u's information unit set at the time T, and Eu(T)=E0(T)+E1(T)+ . . . +En(T); Su(T) is a sum of data amount of the user u's information unit set at the time T;
6) Compare P(T) with Eu(T); and process the data output request according to the comparison result;

7) When Eu(T)<P(T)<Su(T)=Cu(T)+Eu(T),

7.1) The control operation unit accepts the data output request of this time; the control operation unit closes all SEns of all information units in the user u's information unit set, and data in the dynamic storage module of each information unit are totally output to the data output port, namely, the data amount En(T) of the dynamic storage module of each information unit in the set at the time T is totally cleared.

The data amount received by the data output port is accumulated and stored;

The control operation unit adds 1 to the record of the number of times of data output operations of the dynamic storage module in the user u's each information unit;

And the control operation unit records time of occurrence of data output operation of the dynamic storage module in the user u's each information unit;

The control operation unit closes all SEns of all information units in the user u's information unit set;

Wherein regarding the user u's n^{th} information unit, at this time if the record of the number of times of data output operations of its dynamic storage module is w, the time of occurrence of the w^{th} data output operation of the dynamic storage module of the user u's n^{th} information unit is the current time information T as stated in step 2), namely, Tne(w)=T;

Then, at any time t after the time T and before the time T_{HBw1} of the user u's information unit set receiving the heartbeat signal for the first time, t∈(T, T_{HBw1}), the data amount En(t) in the dynamic storage module of the user u's each information unit is totally cleared, and En(t)=Eny(T)=0, wherein n=1, 2, . . . ; After the time T and at the time T_{HBw1} of the user u's information unit set receiving the heartbeat signal for the first time, the data amount in the dynamic storage module of the user u's each information unit En(T_{HBw1})=δEn(T_{HBw1}), wherein n=1, 2, . . . ; wherein δEn(T_{HBw1}) is new data amount generated by the association exciter of the user u's n^{th} information unit at the time T_{HBw1};

7.2) Subsequently, the control operation unit performs the following operations:

7.2.1) The control operation unit closes SCn of the information unit created at latest in the user u's information unit set so that data in the steady-state storage module of the n^{th} information unit may be output;

The control operation unit adds 1 to the number of times of data output operations with respect to the steady-state storage module of the n^{th} information unit, wherein the number of times of data output operations with respect to the steady-state storage module of the n^{th} information unit is represented by m, and m=0, 1, 2, . . . natural number;

And, the control operation unit records time Tn(m) of occurrence of the m^{th} deduction of the data amount of the steady-state storage module of the n^{th} information unit, Tn(m)=T, wherein m=1, 2, 3, . . . , namely, the current time information T as stated in above step 2) is also system-recorded time of occurrence of the m^{th} output of the data amount of the steady-state storage module of the n^{th} information unit; wherein the time of creating the user u's n^{th} information unit is represented by Tn(0);

Compare P(T)−Eu(T) with Cn(T), and Cn(T) is the data amount of the steady-state storage module of the n^{th} information unit of the user u's information unit set at time T;

7.2.1.1) If P(T)−Eu(T)<=Cn(T),

the steady-state storage module of the n^{th} information unit outputs data amount P(T)−Eu(T) to the data output port;

The m^{th} deduction of the steady-state storage module of the n^{th} information unit is: Qn(m)=P(T)−Eu(T);

After the m^{th} deduction, remaining data amount of the steady-state storage module of the n^{th} information unit is:

Cny(T)=Cn(T)−Qn(m);

The data amount received by the data output port is accumulated and stored;

Subsequently, the control operation unit instructs the data output port of the user u's information unit set to perform data amount output, and the output data amount is P(T);

The control operation unit opens SCn of the user u's n^{th} information unit;

The control operation unit closes the user u's heartbeat line control switch SHB;

The control operation unit returns a success response message to the data output request of this time;

The operation of the data output request of this time ends up;

7.2.1.2) If P(T)−Eu(T)>Cn(T),

The data amount in the steady-state storage module of the n^{th} information unit is totally output to the data output port;

The m^{th} deduction of the steady-state storage module of the n^{th} information unit is: Qn(m)=Cn(T);

After the m^{th} deduction, data amount of the steady-state storage module of the n^{th} information unit is:

Cny(T)=Cn(T)−Cn(T)=0;

The data amount received by the data output port is accumulated and stored;

The control operation unit opens SCn of the user u's n^{th} information unit;

7.2.2) The control operation unit closes SCn−1 of the information unit created the second latest in the user u's information unit set so that data in the steady-state storage module of the n−1^{th} information unit may be output;

The control operation unit adds 1 to the number of times of data output operations with respect to the steady-state storage module of the n−1^{th} information unit, wherein the number of times of data output operations with respect to the steady-state storage module of the n−1^{th} information unit is represented by p, and p=0, 1, 2, . . . natural number;

And, the control operation unit records time Tn−1(p) of occurrence of the p^{th} deduction of the data amount of the steady-state storage module of the n−1^{th} information unit, Tn−1(p)=T, wherein p=1, 2, 3, . . . , namely, the current time information T as stated in above step 2) is also system-recorded time of occurrence of the p^{th} output of the data amount of the steady-state storage module of the n−1^{th} information unit; wherein the time of creating the user u's n−1^{th} information unit is represented by Tn−1(0);

The control operation unit compare P(T)−Eu(T)−Cn(T) with Cn−1(T), and Cn−1(T) is the data amount of the steady-state storage module of the n−1^{th} information unit of the user u's information unit set at time T;

7.2.2.1) If P(T)−Eu(T)−Cn(T)<=Cn−1(T),

The steady-state storage module of the n−1^{th} information unit outputs data amount P(T)−Eu(T)−Cn(T) to the data output port;

The p^{th} deduction of the steady-state storage module of the n−1^{th} information unit is:

Qn−1(p)=P(T)−Eu(T)−Cn(T);

After the p^{th} deduction, remaining data amount of the steady-state storage module of the n−1^{th} information unit is:

Cn−1y(T)=Cn−1(T)−Qn−1(p);

The data amount received by the data output port is accumulated and stored;

Subsequently, the control operation unit instructs the data output port of the user u's information unit set to perform data amount output, and the output data amount is P(T);

The control operation unit opens SCn−1 of the user u's n−1^{th} information unit;

The control operation unit closes the user u's heartbeat line control switch SHB;

The control operation unit returns a success response message to the data output request of this time;

The operation of the data output request of this time ends up;

7.2.2.2) If P(T)−Eu(T)−Cn(T)>Cn−1(T),

The data amount in the steady-state storage module of the n−1^{th} information unit is totally output to the data output port;

The p^{th} deduction of the steady-state storage module of the n−1^{th} information unit is: Qn−1(p)=Cn−1(T);

After the p^{th} deduction, data amount of the steady-state storage module of the n−1^{th} information unit is:

Cn−1y(T)=Cn−1(T)−Cn−1(T)=0;

The data amount received by the data output port is accumulated and stored;

The control operation unit opens SCn−1 of the user u's n−1^{th} information unit;

At any time t thereafter, t>Tn−1(p), the data amount of the steady-state storage module of the n−1^{th} information unit Cn−1(t)=0;

The control operation unit executes 7.2.3);

Similarly,

7.2.n-1) The control operation unit closes SC2 of the information unit created the second in the user u's information unit set so that data in the steady-state storage module of the second information unit may be output;

The control operation unit adds 1 to the number of times of data output operations with respect to the steady-state storage module of the second information unit, wherein the number of times of data output operations with respect to the steady-state storage module of the second information unit is represented by r, and r=0, 1, 2, . . . natural number;

And, the control operation unit records time T2(r) of occurrence of the r^{th} deduction of the data amount of the steady-state storage module of the second information unit, T2(r)=T, wherein r=1, 2, 3, . . . , namely, the current time information T as stated in above step 2) is also system-recorded time of occurrence of the r^{th} output of the data amount of the steady-state storage module of the second information unit; wherein the time of creating the user u's second information unit is represented by T2(0);

Compare P(T)−Eu(T)−Cn(T)−Cn−1(T)− . . . −C3(T) with C2(T), and C2(T) is the data amount of the steady-state storage module of the second information unit of the user u's information unit set at time T;

7.2.n-1.1) If P(T)−Eu(T)−Cn(T)−Cn−1(T)− . . . −C3(T)<=C2(T),

The steady-state storage module of the second information unit outputs data amount P(T)−Eu(T)−Cn(T)−Cn−1(T)− . . . −C3(T) to the data output port;

The r^{th} deduction of the steady-state storage module of the second information unit is:

Q2(r)=P(T)−Eu(T)−Cn(T)−Cn−1(T)− . . . −C3(T);

After the r^{th} deduction, remaining data amount of the steady-state storage module of the second information unit is:

C2y(T)=C2(T)−Q2(r);

The data amount received by the data output port is accumulated and stored;

Subsequently, the control operation unit instructs the data output port of the user u's information unit set to perform data amount output, and the output data amount is P(T);

The control operation unit opens SC2 of the user u's second information unit;

The control operation unit closes the user u's heartbeat line control switch SHB;

The control operation unit returns a success response message to the data output request of this time;

The operation of the data output request of this time ends up;

7.2.n-1.2) If P(T)−Eu(T)−Cn(T)−Cn−1 (T)− . . . −C3 (T)>C2(T),

The data amount in the steady-state storage module of the second information unit is totally output to the data output port;

The r^{th} deduction of the steady-state storage module of the second information unit Q2(r)=C2(T);

After the r^{th} deduction, remaining data amount of the steady-state storage module of the second information unit is:

C2y(T)=C2(T)−C2(T)=0;

The control operation unit opens SC2 of the user u's second information unit;

At any time t thereafter, t>T2(r), the data amount of the steady-state storage module of the second information unit C2(t)=0;

The control operation unit executes 7.2.n);

7.2.n) The control operation unit closes SC1 of the information unit created the first in the user u's information unit set so that data in the steady-state storage module of the first information unit may be output;

The control operation unit adds 1 to the number of times of data output operations with respect to the steady-state storage module of the first information unit, wherein the number of times of data output operations with respect to the steady-state storage module of the first information unit is represented by z, and z=0, 1, 2, . . . natural number;

And, the control operation unit records time T1(z) of occurrence of the z^{th} deduction of the data amount of the steady-state storage module of the first information unit, T1(z)=T, wherein z=1, 2, 3, . . . , namely, the current time information T as stated in above step 2) is also system-recorded time of occurrence of the z^{th} output of the data amount of the steady-state storage module of the first information unit; wherein the time of creating the user u's first information unit is represented by T1(0);

Compare P(T)−Eu(T)−Cn(T)−Cn−1(T)− . . . −C3(T)−C2(T) with C1(T), and C1(T) is the data amount of the steady-state storage module of the first information unit of the user u's information unit set at time T;

Since Eu(T)<P(T)<Su(T)=Cu(T)+Eu(T),

P(T)−Eu(T)−Cn(T)−Cn−1(T)− . . . −C3(T)−C2(T)<C1(T)

Then the data amount output by the steady-state storage module of the first information unit to the data output port is P(T)−Eu(T)−Cn(T)−Cn−1(T)− . . . −C3(T)−C2(T);

Namely, the z^{th} deduction of the steady-state storage module of the first information unit is:

Q1(z)=P(T)−Eu(T)−Cn(T)−Cn−1(T)− . . . −C3(T)−C2(T);

After the z^{th} deduction, remaining data amount of the steady-state storage module of the first information unit is:

C1y(T)=C1(T)−Q1(z);

The data amount received by the data output port is accumulated and stored;

Subsequently, the control operation unit instructs the data output port of the user u's information unit set to perform data amount output, and the output data amount is P(T);

The control operation unit opens SC1 of the user u's first information unit;

The control operation unit closes the user u's heartbeat line control switch SHB;

The control operation unit returns a success response message to the data output request of this time;

The operation of the data output request of this time ends up.

Processing the data output request according to the comparison result in said step 5) specifically includes:

5.1) If P(T)>Su(T),

If the control operation unit rejects the data output request of this time,

the control operation unit closes the user u's heartbeat line control switch SHB;

The control operation unit returns a failure response message to the data output request of this time, and its cause is insufficient sum of stored data;

The operation of the data output request of this time ends up;

Or, if the control operation unit receives the data output request of this time, the control operation unit closes all SCns and SEns of all information units in the user u's information unit set so that data in the dynamic storage module and steady-state storage module of each information unit is totally output to the data output port, namely, the data amount Cn(T) and En(T) at time T are totally cleared;

The data amount received by the data output port is accumulated and stored;

Subsequently, the control operation unit instructs the data output port of the user u's information unit set to perform data amount output, and the output data amount is Su(T);

The control operation unit adds 1 respectively to the record of the number of times of data output operations of each steady-state storage module and each dynamic storage module in the user u's each information unit;

And the control operation unit records time of occurrence of data output operation of each steady-state storage module and each dynamic storage module in the user u's each information unit;

The control operation unit opens all SCns and SEns of all information units in the user u's information unit set;

The control operation unit closes the user u's heartbeat line control switch SHB;

The control operation unit returns a success response message to the data output request of this time;

The operation of the data output request of this time ends up;

At any time t thereafter, t>T, the data amount of the steady-state storage module and dynamic storage module of each information unit created prior to the time T in the user u's information unit set is totally cleared.

5.2) If P(T)=Su(T),

The control operation unit accepts the data output request of this time, and the control operation unit closes all SCns and SEns of all information units in the user u's information unit set so that data in the dynamic storage module and steady-state storage module of each information unit is totally output to the data output port, namely, the data amount Cn(T) and En(T) at time T are totally cleared;

The data amount received by the data output port is accumulated and stored;

Subsequently, the control operation unit instructs the data output port of the user u's information unit set to perform data amount output, and the output data amount is Su(T);

The control operation unit adds 1 respectively to the record of the number of times of data output operations of each steady-state storage module and each dynamic storage module in the user u's each information unit;

And the control operation unit records time of occurrence of data output operation of each steady-state storage module and each dynamic storage module in the user u's each information unit;

The control operation unit opens all SCns and SEns of all information units in the user u's information unit set;

The control operation unit closes the user u's heartbeat line control switch SHB;

The control operation unit returns a success response message to the data output request of this time;

The operation of the data output request of this time ends up;

At any time t thereafter, t>T, the data amount of the steady-state storage module and dynamic storage module of each information unit created prior to the time T in the user u's information unit set is totally cleared.

5.3) If P(T)<Su(T), the control operation unit accepts the data output request of this time and performs operation of step 6).

Processing the data output request according to the comparison result in said step 6) specifically comprises:

6.1) If P(T)=Eu(T),

The control operation unit accepts the data output request of this time, and the control operation unit closes all SEns of all information units in the user u's information unit set so that data in the dynamic storage module of each information unit is totally output to the data output port, namely, the data amount En(T) at time T is totally cleared;

The data amount received by the data output port is accumulated and stored;

Subsequently, the control operation unit instructs the data output port of the user u's information unit set to perform data amount output, and the output data amount is Eu(T);

The control operation unit adds 1 to the record of the number of times of data output operations of the dynamic storage module in the user u's each information unit;

And the control operation unit records time of occurrence of data output operation of the dynamic storage module in the user u's each information unit;

The control operation unit opens all SEns of all information units in the user u's information unit set;

The control operation unit closes the user u's heartbeat line control switch SHB;

The control operation unit returns a success response message to the data output request of this time;

The operation of the data output request of this time ends up;

At any time t after the time T and prior to the time T_{HBw1} of the user u's information unit set receiving the heartbeat signal for the first time, t∈(T, T_{HBw1}), the data amount En(t) in the dynamic storage module of the user u's each information unit is totally zero, and represented as En(t)=Eny(T)=0, wherein n=1, 2, . . . ;

After the time T and at the time T_{HBw1} of the user u's information unit set receiving the heartbeat signal for the first time, the data amount in the dynamic storage module of the user u's each information unit En(T_{HBw1})=δEn(T_{HBw1}), wherein n=1, 2, . . . ; wherein δEn(T_{HBw1}) is a new data amount generated by the association exciter of the user u's n^{th} information unit at the time T_{HBw1};

6.2) If P(T)<Eu(T), the control operation unit accepts the data output request of this time and performs the following operations;

6.2.1) The control operation unit closes SEn of the information unit created at latest in the user u's information unit set so that data in the dynamic storage module of the n^{th} information unit may be output;

The control operation unit adds 1 to the number of times of data output operations with respect to the dynamic storage module of the n^{th} information unit, wherein the number of times of data output operations with respect to the dynamic storage module of the n^{th} information unit is represented by w, and w=0, 1, 2, . . . natural number;

And, the control operation unit records time Tne(w) of occurrence of the w^{th} output of data amount of the dynamic storage module of the n^{th} information unit, Tne(w)=T, wherein w=1, 2, 3, . . . , namely, the current time information T as stated in step 2) in the aforesaid claim 9) is also system-recorded time of occurrence of the w^{th} output of the data amount of the dynamic storage module of the n^{th} information unit;

Compare P(T) with En(T), and En(T) is the data amount of the dynamic storage module of the n^{th} information unit of the user u's information unit set at time T;

6.2.1.1) If P(T)<=En(T),

the dynamic storage module of the n^{th} information unit outputs data amount P(T) to the data output port;

The amount of w^{th} output of the dynamic storage module of the n^{th} information unit is: Dn(w)=P(T);

After the w^{th} output, remaining data amount of the dynamic storage module of the n^{th} information unit is:

Eny(T)=En(T)−P(T);

The data amount received by the data output port is accumulated and stored;

Subsequently, the control operation unit instructs the data output port of the user u's information unit set to perform data amount output, and the output data amount is P(T);

The control operation unit opens SEn of the user u's n^{th} information unit;

The control operation unit closes the user u's heartbeat line control switch SHB;

The control operation unit returns a success response message to the data output request of this time;

The operation of the data output request of this time ends up;

Thereafter, at any time t after the time T and prior to the time T_{HBw1} of the user u's information unit set receiving the heartbeat signal for the first time, t∈(T, T_{HBw1}), the data amount En(t) in the dynamic storage module of the user u's n^{th} information unit is: En(t)=Eny(T)=En(T)−P(T);

After the time T and at the time T_{HBw1} of the user u's information unit set receiving the heartbeat signal for the first time, the data amount in the dynamic storage module of the user u's n^{th} information unit is:

En(T_{HBw1})=Eny(T)+δEn(T_{HBw1})=En(T)−P(T)+δEn(T_{HBw1});

wherein δEn(T_{HBw1}) is a new data amount generated by the association exciter of the user u's n^{th} information unit at the time T_{HBw1};

6.2.1.2) If P(T)>En(T),

The data amount in the dynamic storage module of the n^{th} information unit is totally output to the data output port;

The w^{th} deduction of the dynamic storage module of the n^{th} information unit is: Dn(w)=En(T);

After the w^{th} deduction, the remaining data amount of the dynamic storage module of the n^{th} information unit is:

Eny(T)=En(T)−En(T)=0;

The data amount received by the data output port is accumulated and stored;

The control operation unit opens SEn of the user u's n^{th} information unit,

Thereafter, at any time t after the time T and prior to the time T_{HBw1} of the user u's information unit set receiving the heartbeat signal for the first time, t∈(T, T_{HBw1}), the data amount En(t) in the dynamic storage module of the user u's n^{th} information unit is: En(t)=Eny(T)=0;

After the time T and at the time T_{HBw1} of the user u's information unit set receiving the heartbeat signal for the first time, the data amount in the dynamic storage module of the user u's n^{th} information unit is:

En(T_{HBw1})=Eny(T)+δEn(T_{HBw1})=δEn(T_{HBw1});

wherein δEn(T_{HBw1}) is a new data amount generated by the association exciter of the user u's n^{th} information unit at the time T_{HBw1};

The control operation unit executes step 6.2.2);

6.2.2) The control operation unit closes SEn−1 of the information unit created the second latest in the user u's information unit set so that data in the dynamic storage module of the n−1^{th} information unit may be output;

The control operation unit adds 1 to the number of times of data output operations with respect to the dynamic storage module of the n−1^{th} information unit, wherein the number of times of data output operations with respect to the dynamic storage module of the n−1^{th} information unit is represented by v, and v=0, 1, 2, . . . natural number;

And, the control operation unit records time Tₙ₋₁ₑ(v) of occurrence of the v^{th} output of the data amount of the dynamic storage module of the n−1^{th} information unit, Tₙ₋₁ₑ(v)=T, wherein v=1, 2, 3, . . . , namely, the current time information T as stated in step 2) recited in said claim 9) is also system-recorded time of occurrence of the v^{th} output of the data amount of the dynamic storage module of the n−1^{th} information unit;

Compare P(T)−En(T) with En−1(T), and En−1(T) is the data amount of the dynamic storage module of the n−1^{th} information unit of the user u's information unit set at time T;

6.2.2.1) If P(T)−En(T)<=En−1(T),

The dynamic storage module of the n−1^{th} information unit outputs data amount P(T)−En(T) to the data output port;

The v^{th} deduction of the dynamic storage module of the n−1^{th} information unit is: Dn−1(v)=P(T)−En(T);

After the v^{th} deduction, remaining data amount of the dynamic storage module of the n−1^{th} information unit is:

En−1y(T)=En−1(T)−Dn−1(v);

The data amount received by the data output port is accumulated and stored;

Subsequently, the control operation unit instructs the data output port of the user u's information unit set to perform data amount output, and the output data amount is P(T);

The control operation unit opens SEn−1 of the user u's n−1^{th} information unit;

The control operation unit closes the user u's heartbeat line control switch SHB;

The control operation unit returns a success response message to the data output request of this time;

The operation of the data output request of this time ends up;

Thereafter, at any time t after the time T and prior to the time T_{HBw1} of the user u's information unit set receiving the heartbeat signal for the first time, t∈(T, T_{HBw1}), the data amount En(t) in the dynamic storage module of the user u's n−1^{th} information unit is:

En−1(t)=En−1y(T)=En(T)+En−1(T)−P(T);

After the time T and at the time T_{HBw1} of the user u's information unit set receiving the heartbeat signal for the first time, the data amount in the dynamic storage module of the user u's n−1^{th} information unit is:

En−1(T_{HBw1})=En−1y(T)+δEn−1(T_{HBw1})=En(T)+En−1(T)−P(T)+δEn−1(T_{HBw1});

wherein δEn−1(T_{HBw1}) is a new data amount generated by the association exciter of the user u's n−1^{th} information unit at the time T_{HBw1};

6.2.2.2) If P(T)−En(T)>En−1(T),

The data amount in the dynamic storage module of the n−1^{th} information unit is totally output to the data output port;

The v^{th} deduction of the dynamic storage module of the n−1^{th} information unit is: Dn−1 (v)=En−1(T);

After the v^{th} deduction, data amount of the dynamic storage module of the n−1^{th} information unit is:

En−1y(T)=En−1(T)−En−1(T)=0;

The data amount received by the data output port is accumulated and stored;

The control operation unit opens SEn−1 of the user u's n−1^{th} information unit;

Thereafter, at any time t after the time T and prior to the time T_{HBw1} of the user u's information unit set receiving the heartbeat signal for the first time, t∈(T, T_{HBw1}), the data amount En−1(t) in the dynamic storage module of the user u's n−1^{th} information unit is: En−1(t)=En−1y(T)=0;

After the time T and at the time T_{HBw1} of the user u's information unit set receiving the heartbeat signal for the first time, the data amount in the dynamic storage module of the user u's n−1^{th} information unit is:

En−1(T_{HBw1})=En−1y(T)+δEn−1(T_{HBw1})=δEn−1(T_{HBw1});

wherein δEn−1(T_{HBw1}) is a new data amount generated by the association exciter of the user u's n−1^{th} information unit at the time T_{HBw1};

The control operation unit executes step 6.2.3);

Similarly,

6.2.n-1) The control operation unit closes SE2 of the information unit created the second in the user u's information unit set so that data in the dynamic storage module of the second information unit may be output;

The control operation unit adds 1 to the number of times of data output operations with respect to the dynamic storage module of the second information unit, wherein the number of times of data output operations with respect to the dynamic storage module of the second information unit is represented by r, and r=0, 1, 2, . . . natural number;

And, the control operation unit records time T2e(r) of occurrence of the r^{th} output of the data amount of the dynamic storage module of the second information unit, T2e(r)=T, wherein r=1, 2, 3, . . . , namely, the current time information T as stated in step 2) in the aforesaid claim 9) is also system-recorded time of occurrence of the r^{th} output of the data amount of the dynamic storage module of the second information unit;

Compare P(T)−En(T)−En−1(T)− . . . −E3(T) with E2(T), and E2(T) is the data amount of the dynamic storage module of the second information unit of the user u's information unit set at time T;

6.2.n-1.1) If P(T)−En(T)−En−1(T)− . . . −E3(T)<=E2(T),

The dynamic storage module of the second information unit outputs data amount P(T)−En(T)−En−1(T)− . . . −E3 (T) to the data output port;

The r^{th} deduction of the dynamic storage module of the second information unit is:

D2(r)=P(T)−En(T)−En−1(T)− . . . −E3(T);

After the r^{th} deduction, remaining data amount of the dynamic storage module of the second information unit is:

E2y(T)=E2(T)−D2(r);

The data amount received by the data output port is accumulated and stored;

Subsequently, the control operation unit instructs the data output port of the user u's information unit set to perform data amount output, and the output data amount is P(T);

The control operation unit opens SE2 of the user u's second information unit;

The control operation unit closes the user u's heartbeat line control switch SHB;

The control operation unit returns a success response message to the data output request of this time;

Thereafter, at any time t after the time T and prior to the time T_{HBw1} of the user u's information unit set receiving the heartbeat signal for the first time, t∈(T, T_{HBw1}), the data amount E2(t) in the dynamic storage module of the user u's second information unit is:

E2(t)=E2y(T)=En(T)+En−1(T)+ . . . +E2(T)−P(T);

After the time T and at the time T_{HBw1} of the user u's information unit set receiving the heartbeat signal for the first time, the data amount in the dynamic storage module of the user u's second information unit is:

E2(T_{HBw1})=E2y(T)+δE2(T_{HBw1})=En(T)+En−1(T)+ . . . +E2(T)−P(T)+δE2(T_{HBw1});

wherein δEn2(T_{HBw1}) is a new data amount generated by the association exciter of the user u's second information unit at the time T_{HBw1};

The operation of the data output request of this time ends up;

6.2.n-1.2) If P(T)−En(T)−En−1(T)− . . . −E3(T)>E2(T),

The data amount in the dynamic storage module of the second information unit is totally output to the data output port;

The r^{th} deduction D2(r)=E2(T);

After the r^{th} deduction, remaining data amount of the dynamic storage module of the second information unit is:

E2y(T)=E2(T)−E2(T)=0;

The data amount received by the data output port is accumulated and stored;

The control operation unit opens SE2 of the user u's second information unit;

Thereafter, at any time t after the time T and prior to the time T_{HBw1} of the user u's information unit set receiving the heartbeat signal for the first time, t∈(T, T_{HBw1}), the data amount E2(t) in the dynamic storage module of the user u's second information unit is: E2(t)=E2y(T)=0;

After the time T and at the time T_{HBw1} of the user u's information unit set receiving the heartbeat signal for the first time, the data amount in the dynamic storage module of the user u's second information unit is:

E2(T_{HBw1})=E2y(T)+δE2(T_{HBw1})=δE2(T_{HBw1});

wherein δEn2(T_{HBw1}) is a new data amount generated by the association exciter of the user u's second information unit at the time T_{HBw1};

The control operation unit executes step 6.2.n);

6.2.n) The control operation unit closes SE1 of the information unit created the first in the user u's information unit set so that data in the dynamic storage module of the first information unit may be output;

The control operation unit adds 1 to the number of times of data output operations with respect to the dynamic storage module of the first information unit, wherein the number of times of data output operations with respect to the dynamic storage module of the first information unit is represented by z, and z=0, 1, 2, . . . natural number;

And, the control operation unit records time T1e(z) of occurrence of the z^{th} output of the data amount of the dynamic storage module of the first information unit, T1e(z)=T, wherein z=1, 2, 3, . . . , namely, the current time information T as stated in step 2) in the aforesaid claim 9 is also system-recorded time of occurrence of the z^{th} output of the data amount of the dynamic storage module of the first information unit;

Compare P(T)−En(T)−En−1(T)− . . . −E3(T)−E2(T) with E1(T), and E1(T) is the data amount of the dynamic storage module of the first information unit of the user u's information unit set at time T;

Since P(T)<Eu(T)=E1(T)+E2(T)+En(T),

P(T)−En(T)−En−1(T)− . . . −E3(T)−E2(T)<E1(T)

Then the data amount output by the dynamic storage module of the first information unit to the data output port:

P(T)−En(T)−En−1(T)− . . . −E3(T)−E2(T);

Namely, the z^{th} deduction of the dynamic storage module of the first information unit is:

D1(z)=P(T)−En(T)−En−1(T)− . . . −E3(T)−E2(T);

After the z^{th} deduction, remaining data amount of the dynamic storage module of the first information unit is:

E1y(T)=E1(T)−D1(z);

The data amount received by the data output port is accumulated and stored;

Subsequently, the control operation unit instructs the data output port of the user u's information unit set to perform data amount output, and the output data amount is P(T);

The control operation unit opens SE1 of the user u's first information unit;

The control operation unit closes the user u's heartbeat line control switch SHB;

The control operation unit returns a success response message to the data output request of this time;

The operation of the data output request of this time ends up;

Thereafter, at any time t after the time T and prior to the time T_{HBw1} of the user u's information unit set receiving the heartbeat signal for the first time, t∈(T, T_{HBw1}), the data amount E1(t) in the dynamic storage module of the user u's first information unit is:

E1(t)=E1y(T)=En(T)+En−1(T)+ . . . +E2(T)+E1(T)−P(T);

After the time T and at the time T_{HBw1} of the user u's information unit set receiving the heartbeat signal for the first time, the data amount in the dynamic storage module of the user u's first information unit is:

E1(T_{HBw1})=E1y(T)+δE1(T_{HBw1})=En(T)+En−1(T)+ . . . +E2(T)+E1(T)−P(T)+δE1(T_{HBw1});

wherein δE1(T_{HBw1}) is a new data amount generated by the association exciter of the user u's first information unit at the time T_{HBw1};

6.3) If P(T)>Eu(T), the control operation unit executes operation of step 7).

After said step (7.2.1.1), at any time t before next deduction of the steady-state storage module of the n^{th} information unit, namely, before occurrence of the m+1^{th} deduction, t (Tn(m), Tn(m+1)), the data amount Cn(t) of the steady-state storage module of the n^{th} information unit is:

Cn(t)=Cny(T)=Cn(T)−Qn(m)=Eu(T)+Cn(T)−P(T);

After said step 7.2.1.2), at any time t, t>Tn(m), the data amount of the steady-state storage module of the n^{th} information unit Cn(t)=0; after said step 7.2.2.1), at any time t before occurrence of deduction of next time, namely of the p+1^{th} time, t∈(Tn−1(p), Tn−1(p+1)), the data amount Cn−1(t) of the steady-state storage module of the n−1^{th} information unit is:

Cn−1(t)=Cn−1y(T)=Cn−1(T)−Qn−1(p)=Eu(T)+Cn(T)+Cn−1(T)−P(T);

after said step 7.2.n-1.1), at any time t before occurrence of deduction of next time, namely of the r+1^{th} time, t (T2(r), T2(r+1)), the data amount C2(t) of the steady-state storage module of the second information unit is:

C2(t)=C2y(T)=C2(T)−Q2(r)=Eu(T)+Cn(T)+Cn−1(T)+ . . . +C3(T)+C2(T)−P(T);

after said step 7.2.n), at any time t before occurrence of deduction of next time, namely of the z+1^{th} time, t∈(T1(z), T1(z+1)), the data amount C1(t) of the steady-state storage module of the first information unit is:

C1(t)=C1y(T)=C1(T)−Q1(z)=Eu(T)+Cn(T)+Cn−1(T)+ . . . +C3(T)+C2(T)+C1(T)−P(T).

After the control operation unit opens the user u's heartbeat line control switch SHB in said step 3), during a time period from the time T when the control operation unit opens the user u's heartbeat line control switch SHB to time tc when the control operation unit closes the user u's heartbeat line control switch SHB again, if the control operation unit receives a data output request with respect to the user u's information unit set, the method further comprises the following steps:

If the control operation unit rejects the data output request of this time, it returns a failure response message to the data output request of this time, and its cause is that the system is busy; the operation of the data output request of this time ends up;

Or, if the control operation unit accepts the data output request of this time, the control operation unit delays the time of data output operation of the data output request of this time so that time T_{b2} of occurrence of the data output operation of the user u's information unit set this time by the control operation unit is T_{b2}=tc+δT or T_{b2}>tc+δT.

After the control operation unit opens the user u's heartbeat line control switch SHB in said step 3), the method further comprises the following steps:

during a time period from the time T when the control operation unit opens the user u's heartbeat line control switch SHB to time tc when the control operation unit closes the user u's heartbeat line control switch SHB again, the heartbeat count register in the information unit set records the number h of the received heartbeat signals, h=0, 1, 2, . . . ;

at the time when the first heartbeat signal comes after the heartbeat line control switch SHB closes again, namely, at the time when the h+1^{th} heartbeat signal comes after the control switch SHB closes, a heartbeat number field value in the heartbeat signal sent from the heartbeat count register is h+1, wherein h=0, 1, 2, . . . .

After the control operation unit opens the user u's heartbeat line control switch SHB in said step 3), during a time period from the time T when the control operation unit opens the user u's heartbeat line control switch SHB to time tc when the control operation unit closes the user u's heartbeat line control switch SHB again, if the control operation unit receives a data input request with respect to the user u's information unit set, the method further comprises the following steps:

If the control operation unit rejects the data input request of this time, it returns a failure response message to the data input request of this time, and its cause is that the system is busy; the operation of the data input request of this time ends up;

Or, if the control operation unit accepts the data input request of this time, the control operation unit delays the time of data input operation of the data input request of this time so that time Tᵢ₂ of occurrence of the data input operation of the user u's information unit set this time by the control operation unit (namely, the system-recorded time of occurrence of the data input operation of this time) Tᵢ₂>tc.

In the data output flow of the information unit set, as for the information unit set with n information units, during the user u's operation of data output request one time, if remaining data amount after the data amount in the steady-state storage modules of a information units (a=0, 1, 2, . . . , n) is deducted is zero, the control operation unit moves these a information units wherein the data amount of the steady-state storage modules is zero from the user u's information unit set into the user u's information unit historical record table when the operation of the data output request ends up; and, when the user u's next information unit set data input request comes, the control operation unit records the number of times of the data input operation of this time as n−a+1; this makes the data amount of the steady-state storage module in each information unit of the information unit set is not equal to zero, thereby improving a processing efficiency of this system.

The present invention can reflect situations of changes of an excitation rate in a short time period such as 1 second, 2 seconds . . . , whereas ratio change within a time period (e.g., within 3 months or half a year) in the prior art is usually fixed, namely, cannot be reflected.

For example, current bank deposit interest calculation manners includes current deposit interest-calculating mode and fixed deposit interest-calculating mode. The fixed deposit interest-calculating mode means calculating the interest on a deposit expiry date in the manner: principal*annual interest rate*scheduled time of fixed deposit. The interest for the overdue portion is calculated as per current deposit mode. That is to say, a change of interest rate is fixed and invariable in a short time period (1 second, 2 seconds, . . . ), and the interest varies with time within a time period. Although the interest amount changes with time measured with second as a unit, changes of the interest rate along with a shorter time period (e.g., measured with second with a unit) are not reflected. Usually, the interest rate in a longer time period (e.g., three months, half a year or the like) does not exhibit changes.

If the interest rate in a financial management system is set as the excitation rate, and if the user's data information is stored in the system of the present invention, each user will possess his own account (formed by a series of storage modules in the information unit). In the system of the present invention, since the excitation rate in(t) in the information unit gradually increases as time t shifts, those subaccounts created earlier among those subaccounts whose principal is not zero, among the user's all subaccounts, enjoy a larger interest rate. Hence, in the system, as for each deposit operation of the user (namely, the operation of data input request), a current interest rate of each deposit is different. The interest rate of the latest deposit is smaller than the current interest rate of previous deposits. To this end, the system needs to create an individual subaccount for each deposited capital (namely, create a new information unit) to implement real-time calculation and corresponding dynamic exhibition of the interest rate and interest sum of each deposited capital, as shown in FIG. 4.

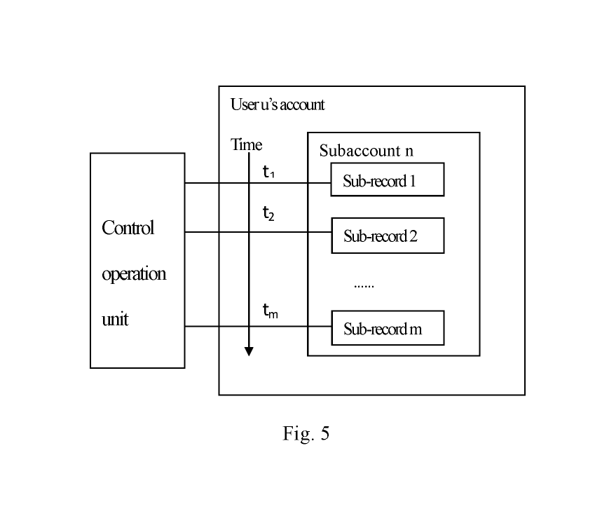

When the user's withdrawal operation (namely, operation of the data output request) updates related information in the subaccount, historical operation record of this subaccount will be recorded in this subaccount, as shown in FIG. 5.

The user's deposit service account is displayed in the following table:

| Account number | xxxx-xxxx-xxxx-xxx | | | | |
|---|---|---|---|---|---|
| Account-opening data | yyyy-mm-dd | | | | |
| Current data and time | yyyy-mm-dd, hh:mm:ss | | | | |
| Account total sum | xxxxxxx.xxxx | | | | |
| Accumulated interest income | xxxx.xxxx | | | | |
| | | | Real-time | Accumulated | |
| Serial | Deposit data | Subaccount | interest | interest | Interest |
| No. | and time | sum | rate | amount | balance |
| 1 | yyyy-mm-dd, hh:mm:ss | xxxxx.xxxx | x.xx % | xx.xxxx | xx.xxxx |
| 2 | yyyy-mm-dd, hh:mm:ss | xxxxx.xxxx | x.xx % | xx.xxxx | xx.xxxx |
| 3 | yyyy-mm-dd, hh:mm:ss | xxxxx.xxxx | x.xx % | xx.xxxx | xx.xxxx |
| . . . | . . . | . . . | . . . | . . . | . . . |
| Total | | xxxxxxx.xxxx | | xxxx.xxxx | xxx.xxxx |

Click sub account to view detailed account information
Deposit/withdraw
Display historical accounts

If the subaccount has withdrawal history, the historical operation record of the subaccount may be viewed by clicking the page, as shown in the following table:

Subaccounts whose principal has already become zero are diverted into historical accounts and will not be displayed in the subaccount page, and the user may view detailed information of historical accounts by clicking the page, as shown in the following table:

In the above tables, so long as the principal of the subaccounts is not equal to zero, information in the subaccounts in the tables such as real-time interest rate, accumulated interest sum and interest balance changes in real time as per second. So long as the principal of at least one subaccount in the user's accounts is not equal to zero, display of information such as the user's account total sum and accumulated interest income also changes dynamically as per second. This enables the user to sense dynamical changes of the account capital in real time.

Through application of the present embodiment,

1) Upon depositing, the user needn't pre-set deposit time; the interest rate and interest amount of each deposit constantly increases every minute and every second, and the user can sense dynamic increase of saved capital;

2) The user enjoys larger freedom in terms of withdrawal time and sum, and partial withdrawal does not affect the interest rate enjoyed by remaining deposited money; when the user draws money, the system first draws money from the interest of subaccounts, and then from the principal in a reverse order of the creation time of subaccounts, and a total value of capital in the user's account can be maximized;

3) Improve user's experience and attraction of bank saving service, particularly for the Internet users and youngster group.

Although the present invention has already been described by way of examples and preferred embodiments, it should be appreciated that the present invention is not limited to the disclosed embodiments. On the contrary, the present invention is intended to cover various modifications and similar configurations (because they are obvious for those skilled in the art). Hence, the scope of the appended claims should be endowed the broadest interpretation to enable it to cover all these modifications and similar configurations.

What is claimed is:

1. A real-time processing system for an information unit set, wherein the real-time system comprises: a control operation unit, a time source unit and a user information unit set; wherein,
the control operation unit creates a user information unit set for each registered user upon registration; the control operation unit is further configured to implement data accumulation, data comparison, and a data difference after data comparison;
the time source unit is configured to provide time for the control operation unit; the time source unit is further configured to provide a periodic heartbeat signal for each user's information unit set;
said each user's information unit set comprises: a data input port, a data output port, a heartbeat line control switch and an information unit; wherein, when the user's information unit set is created, if there is not any input data in the set, the number of information units in the set is 0; when there is input data for the first time in the set, the control operation unit creates the first information unit in the set; in the same way, when there is input data for the n^{th} time in the set, the control operation unit creates the n^{th} information unit in the set;
each set of information unit in the user's information unit set further comprises:
a steady-state storage module: connected to the control operation unit via a control line to perform a control operation of the control operation unit; connected to the data input port through a data line to store data amount input by the user information unit set; connected with a data output control switch of the steady-state storage module through a data line so that when the switch is closed, the steady-state storage module may output data amount to the data output port; connected with an association exciter through an excitation line to provide an excitation base for the association exciter;
the association exciter: connected with the steady-state storage module through an excitation line to receive excitation of data amount in the steady-state storage module; connected with the time source unit through a heartbeat line to receive a heartbeat signal from the time source unit; at the time of receiving the heartbeat signal each time, the association exciter generates a new data amount for one time under excitation of the data amount in the steady-state storage module; the new data amount generated at this time is: a product of the three parameters: the data amount in the steady-state storage module at this time, an excitation rate in the association exciter at this time and a time length of a heartbeat signal cycle; furthermore, once the association exciter receives at least one heartbeat signal, the excitation rate in the association exciter changes; the association exciter is connected with a dynamic storage module via a data line, and the new data amount generated in the association exciter each time is output to the dynamic storage module;
the dynamic storage module: connected with the control operation unit through a control line to perform control operation of the control operation unit; connected with the association exciter through a data line to store the new data amount generated in the association exciter each time; connected with a data output control switch of the dynamic storage module through a data line so that the dynamic storage module may output data amount to the data output port when the switch is closed;
the data output control switch of the steady-state storage module: connected with the steady-state storage module and the data output port respectively through a data line; when the switch is closed, the steady-state storage module may output data amount to the data output port; when the switch is opened, the steady-state storage module cannot output data amount to the data output port;
the data output control switch of the dynamic storage module: connected with the dynamic storage module and the data output port respectively through a data line; when the switch is closed, the dynamic storage module may output data amount to the data output port; when the switch is opened, the dynamic storage module cannot output data amount to the data output port.

2. The real-time processing system for an information unit set according to claim 1, wherein the data output port is connected, via a data line, with the data output control switch of each steady-state storage module and the data output control switch of each dynamic storage module in the information unit set; when the switches are closed, data amount received by the data output port from the corresponding storage module connected by the data output control switch is accumulated and stored;
the data output port is connected with the control operation unit via a control line, and performs a data amount output operation according to an operation instruction of the control operation unit.

3. The real-time processing system for an information unit set according to claim 1, wherein each user's information unit set further comprises a heartbeat count register; the heartbeat count register is connected with the time source unit via a heartbeat line and receives a heartbeat signal from the time source unit; the heartbeat count register is connected with a heartbeat line control switch via a heartbeat line; while the heartbeat line control switch is opened, the heartbeat count register records the number h of received heartbeat signals; at the time when the first heartbeat signal comes after the heartbeat line control switch is closed again, the heartbeat count register broadcasts and sends the heartbeat signal to all exciter in the user's information unit set, and a value of a heartbeat number field in the heartbeat signal is h+1, wherein h is the number of heartbeat signals recorded by the heartbeat count register during the opening of the heartbeat line control switch, and h=0, 1, 2 . . . .

4. The real-time processing system for an information unit set according to claim 1, wherein the time source unit is capable of providing the heartbeat signal to each user's information unit set, and a time length of a time period δT of the heartbeat signal is 1 second, or 2 seconds, or 3 seconds, or 4 seconds, or 5 seconds, or 6 seconds, or 10 seconds, or 12 seconds, or 15 seconds, or 20 seconds, or 30 seconds or 60 seconds.

5. The real-time processing system for an information unit set according to claim 1, wherein once the association exciter receives at least one heartbeat signal, an excitation rate of the association exciter increases constantly; in the user's information unit set, as for those information units with the data amount not being zero, the association exciter in the information unit created earlier in the set has a larger excitation rate.

6. The real-time processing system for an information unit set according to claim 1, wherein an initial state of the heartbeat line control switch upon creation in each user's information unit set is closed.

7. A real-time processing method for an information unit set, wherein the real-time system for the information unit set involved in the method comprises: a control operation unit, a time source unit and a user information unit set; the method comprises a data input flow of the information unit set and a data output flow of the information unit set; wherein the data input flow of the information unit set comprises:
upon receiving a data input request to the user's information unit set, the control operation unit performs the following operations:
R1) the control operation unit checks the data input request; if the check fails, rejects the data input request of this time and returns corresponding cause information;
if the check passes, continues to perform the following operations;
R2) the control operation unit reads current time information T from the time source unit and records it;
R3) the control operation unit adds 1 to the number n of times of the user's data input operations;
wherein the number of times of the user's data input operations is designated by n, and n=0, 1, 2, . . . , natural number;
time of the user's data input operation of the n^{th} time Tu(n)=T, and n=1, 2, 3, . . . ;
wherein time of creating the user's information unit set is represented by Tu(0);
R4) the control operation unit creates a new information unit, namely, the n^{th} information unit, in the user's information unit set;
wherein time Tn(0) of creating the user's n^{th} information unit is the previously-recited time T, namely, Tn(0)=Tu(n)=T, and n=1, 2, 3 . . . ;
the user's n^{th} information unit contains:
module 1: a steady-state storage module which stores data amount Cn;
an initial value of Cn upon the creation time Tn(0) is input data amount Lu of the data input request of this time received by the user from the data input port at time T, and expressed as Cn(Tn(0))=Lu(T);
module 2: an association exciter,
i(Tn(0)) as an initial excitation rate of the association exciter at the creation time Tn(0) is represented by in(0); the excitation rate after it receives the first heartbeat signal is represented as in(1), in(0)=in(1) or in(0)<in(1); the excitation rate after it receives the second heartbeat signal is represented as in(2), and in(1)=in(2) or in(1)<in(2); similarly, the excitation rate after it receives the g^{th} heartbeat signal is represented as in(g), and in(g−1)=in(g) or in(g−1)<in(g); the excitation rate after it receives the g+1^{th} heartbeat signal is represented as in(g+1), and in(g)=in(g+1) or in(g)<in(g+1);
so long as the data amount in the steady-state storage module is not equal to zero, as time shifts, the time T_{HB} when the association exciter receives the heartbeat signal each time generates a new data amount δEn one time under excitation of the data amount Cn(T_{HB}) in the steady-state storage module:
δEn=Cn(T_{HB})*in(g)*δT=δEn(g);
wherein δT is a time length of a cycle of the time source unit sending the heartbeat signal; T_{HB} is time when the association exciter receives the heartbeat signal, T_{HB}=T₁+(g−1)*δT=T_{g}, namely, T_{HB} is also time of the time source unit sending the g^{th} heartbeat signal since the time of creating the n^{th} information unit; T₁ is time of the time source unit sending the first heartbeat signal since the time of creating the n^{th} information unit; Cn(T_{HB}) is the data amount of the steady-state storage module of the user's n^{th} information unit at the time T_{HB}; in(g) is the excitation rate when the number of the heartbeat signals received by the association exciter reaches g;
module 3: a dynamic storage module which stores data amount En;
as an initial value of En at the creation time Tn(0), En(Tn(0))=0;
then so long as the data amount in the steady-state storage module is not equal to zero, as time shifts, after the association exciter receives the heartbeat signal each time, the association exciter outputs new data amount δEn(g) once to the dynamic storage module; at the time t, the data amount accumulatively input by the user's n^{th} information unit from the association exciter is represented by SigEn(t);
module 4: a data output control switch of the steady-state storage module, represented as SCn;
when SCn in the user's n^{th} information unit is in an opened state, data in the steady-state storage module of the n^{th} information unit cannot be output, and the data amount in the steady-state storage module will not reduce; when SCn is in a closed state, the data in the steady-state storage module may be output;
module 5: a data output control switch of the dynamic storage module, represented as SEn;
when SEn in the user's n^{th} information unit is in an opened state, data in the dynamic storage module of the n^{th} information unit cannot be output, and the data amount in the dynamic storage module will not reduce; when SEn is in a closed state, the data in the dynamic storage module may be output.

8. The real-time processing method for an information unit set according to claim 7, wherein at time T_{HB} when the association exciter receives the heartbeat signal, new data amount δEn generated by the association exciter under the excitation of the data amount Cn(T_{HB}) in the steady-state storage module may further be as follows:
if a heartbeat number field value in the heartbeat signal received by the association exciter in the user's n^{th} information unit at the time THB is h+1, and h=0, 1, 2, . . . ; the new data amount δEn generated by the association exciter at this time is:
δEn=Cn(T_{HB})*(in(g+1)+ . . . +in(g+h)+in(g+h+1))*δT=Cn(T₁+(g+h)*δT)*(in(g+1)+ . . . +in(g+h)+in(g+h+1))*δT=δEn(g+h+1);
wherein the current time T_{HB}=T₁+(g+h)*δT=T_{g}+(h+1)*δT=T_{g+h+1},
δT is a time length of a cycle of the time source time sending the heartbeat signal;
T₁ is time of the time source unit sending the first heartbeat signal since the time of creating the n^{th} information unit;
T_{g} is time of the time source unit sending the g^{th} heartbeat signal since the time of creating the n^{th} information unit, T_{g}=T₁+(g−1)*δT; T_{g} is simultaneously time of the association exciter receiving the heartbeat signal for the latest time before the current time T_{HB};
Cn(T_{HB}) is data amount of the steady-state storage module of the user's n^{th} information unit at the current time T_{HB}, Cn(T_{HB})=Cn(t1+(g+h)*δT)=Cn(T_{g+h+1});
in(g+1) is an excitation rate when the number of the heartbeat signals received by the association exciter reaches g+1;
in(g+2) is an excitation rate when the number of the heartbeat signals received by the association exciter reaches g+2;
similarly,
in(g+h) is an excitation rate when the number of the heartbeat signals received by the association exciter reaches g+h;
in(g+h+1) is an excitation rate when the number of the heartbeat signals received by the association exciter reaches g+h+1.

9. The real-time processing method for an information unit set according to claim 7, wherein at the time t, the data amount SigEn(t) accumulatively input by the user's n^{th} information unit from the association exciter is as follows:
at and after the creation time Tn(0) of the association exciter and prior to the time T₁ of receiving the heartbeat signal for the first time, namely, when t∈[Tn(0), T₁), SigEn(t)=0; wherein T₁∈[Tn(0), Tn(0)+δT), and δT is a time length of a cycle of the time source time sending the heartbeat signal;
at and after the time T₁ of the association exciter receiving the heartbeat signal for the first time and prior to time T₂ of receiving the heartbeat signal for the second time, namely, when t∈[T₁, T₂), SigEn(t)=δEn(1); wherein δEn(1) is the new data amount generated when the association exciter receives the heartbeat signal for the first time;
at and after the time T₂ of the association exciter receiving the heartbeat signal for the second time and prior to time T₃ of receiving the heartbeat signal for the third time, namely, when t∈[T₂, T₃), SigEn(t)=δEn(1)+δEn(2); wherein δEn(2) is the new data amount generated when the association exciter receives the heartbeat signal for the second time;
similarly,
at and after the time Tⱼ of the association exciter receiving the heartbeat signal for the j^{th} time and prior to time Tⱼ₊₁ of receiving the heartbeat signal for the j+1^{th} time, namely, when t∈[Tⱼ, Tⱼ₊₁), SigEn(t)=δEn(1)+δEn(2)+ . . . +δEn(j); wherein δEn(j) is the new data amount generated when the association exciter receives the heartbeat signal for the j^{th} time.

10. The real-time processing method for an information unit set according to claim 7, wherein the data output flow of the information unit set comprises:
the control operation unit receives, at the time T, a data output request with respect to the user's information unit set; when a request value is P(T), the following operations are performed:
1) the control operation unit checks the data output request; if the check fails, rejects the data output request of this time and returns corresponding cause information;
if the check passes, continues to perform the following operations:
2) the control operation unit reads current time information T from the time source unit and records it;
the time T here is system-recorded time of the control operation unit of receiving the data output request with respect to the user's information unit set, as well as system-recorded time of the control operation unit of operating data output with respect to the user's information unit set;
3) the control operation unit opens the user's heartbeat line control switch SHB;
4) the control operation unit adds 1 to a record of the number of times of data output operations with respect to the user's information unit set; wherein the number of times of data output operations with respect to the user's information unit set is represented by b, and b=0, 1, 2, . . . natural number;
and, the control operation unit records time Tuo(b) of the b^{th} data output operation with respect to the user u's information unit set, and Tuo(b)=T, wherein b=1, 2, 3, . . . ; that is, the system-recorded time T of the control operation unit of operating data output with respect to the user's information unit set as stated in the above step 2) is also the system-recorded time of the b^{th} data output operation with respect to the user u's information unit set;
5) compare P(T) with Su(T), Su(T)=Cu(T)+Eu(T); and process the data output request according to the comparison result; wherein Cu(T) is a sum of data amount of the steady-state storage module in the user's information unit set at the time T, and Cu(T)=C0(T)+C1(T)+ . . . +Cn(T); Eu(T) is a sum of data amount of the dynamic storage module in the user's information unit set at the time T, and Eu(T)=E0(T)+E1 (T)+ . . . +En(T); Su(T) is a sum of data amount of the user's information unit set at the time T;
6) compare P(T) with Eu(T); and process the data output request according to the comparison result;
7) when Eu(T)<P(T)<Su(T)=Cu(T)+Eu(T),
7.1) the control operation unit accepts the data output request of this time; the control operation unit closes all SEns of all information units in the user's information unit set, and data in the dynamic storage module of each information unit are totally output to the data output port, namely, the data amount En(T) of the dynamic storage module of each information unit in the set at the time T is totally cleared;
the data amount received by the data output port is accumulated and stored;
the control operation unit adds 1 to the record of the number of times of data output operations of the dynamic storage module in the user's each information unit;
and the control operation unit records time of occurrence of data output operation of the dynamic storage module in the user's each information unit;
the control operation unit closes all SEns of all information units in the user's information unit set;
wherein regarding the user's n^{th} information unit, at this time if the record of the number of times of data output operations of its dynamic storage module is w, the time of occurrence of the w^{th} data output operation of the dynamic storage module of the user's n^{th} information unit is the current time information T as stated in step 2), namely, Tne(w)=T;
then, at any time t after the time T and before the time T_{HBw1} of the user's information unit set receiving the heartbeat signal for the first time, t∈(T, T_{HBw1}), the data amount En(t) in the dynamic storage module of the user's each information unit is totally cleared, and En(t)=Eny(T)=0, wherein n=1, 2, . . . ;
after the time T and at the time T_{HBw1} of the user's information unit set receiving the heartbeat signal for the first time, the data amount in the dynamic storage module of the user's each information unit En(T_{HBw1})=δEn(T_{HBw1}), wherein n=1, 2, . . . ; wherein δEn(T_{HBw1}) is new data amount generated by the association exciter of the user's n^{th} information unit at the time T_{HBw1};
7.2) subsequently, the control operation unit performs the following operations:
7.2.1) the control operation unit closes SCn of the information unit created at latest in the user's information unit set so that data in the steady-state storage module of the n^{th} information unit may be output;
the control operation unit adds 1 to the number of times of data output operations with respect to the steady-state storage module of the n^{th} information unit, wherein the number of times of data output operations with respect to the steady-state storage module of the n^{th} information unit is represented by m, and m=0, 1, 2, . . . natural number;
and, the control operation unit records time Tn(m) of occurrence of the m^{th} deduction of the data amount of the steady-state storage module of the n^{th} information unit, Tn(m)=T, wherein m=1, 2, 3, . . . , namely, the current time information T as stated in above step 2) is also system-recorded time of occurrence of the m^{th} output of the data amount of the steady-state storage module of the n^{th} information unit; wherein the time of creating the user's n^{th} information unit is represented by Tn(0);
compare P(T)−Eu(T) with Cn(T), and Cn(T) is the data amount of the steady-state storage module of the n^{th} information unit of the user's information unit set at time T;
7.2.1.1) if P(T)−Eu(T)<=Cn(T),
the steady-state storage module of the n^{th} information unit outputs data amount P(T)−Eu(T) to the data output port;
the m^{th} deduction of the steady-state storage module of the n^{th} information unit is: Qn(m)=P(T)−Eu(T);
after the m^{th} deduction, remaining data amount of the steady-state storage module of the n^{th} information unit is:
Cny(T)=Cn(T)−Qn(m);
the data amount received by the data output port is accumulated and stored;
subsequently, the control operation unit instructs the data output port of the user's information unit set to perform data amount output, and the output data amount is P(T);
the control operation unit opens SCn of the user's n^{th} information unit;
the control operation unit closes the user's heartbeat line control switch SHB;
the control operation unit returns a success response message to the data output request of this time;
the operation of the data output request of this time ends up;
7.2.1.2) if P(T)−Eu(T)>Cn(T),
the data amount in the steady-state storage module of the n^{th} information unit is totally output to the data output port;
the m^{th} deduction of the steady-state storage module of the n^{th} information unit is: Qn(m)=Cn(T);
after the m^{th} deduction, data amount of the steady-state storage module of the n^{th} information unit is:
Cny(T)=Cn(T)−Cn(T)=0;
the data amount received by the data output port is accumulated and stored;
the control operation unit opens SCn of the user's n^{th} information unit;
7.2.2) the control operation unit closes SCn−1 of the information unit created the second latest in the user's information unit set so that data in the steady-state storage module of the n−1^{th} information unit may be output;
the control operation unit adds 1 to the number of times of data output operations with respect to the steady-state storage module of the n−1^{th} information unit, wherein the number of times of data output operations with respect to the steady-state storage module of the n−1^{th} information unit is represented by p, and p=0, 1, 2, . . . natural number;
and, the control operation unit records time Tn−1(p) of occurrence of the p^{th} deduction of the data amount of the steady-state storage module of the n−1^{th} information unit, Tn−1(p)=T, wherein p=1, 2, 3, . . . , namely, the current time information T as stated in above step 2) is also system-recorded time of occurrence of the p^{th} output of the data amount of the steady-state storage module of the n−1^{th} information unit; wherein the time of creating the user's n−1^{th} information unit is represented by Tn−1(0);
the control operation unit compare P(T)−Eu(T)−Cn(T) with Cn−1(T), and Cn−1(T) is the data amount of the steady-state storage module of the n−1^{th} information unit of the user's information unit set at time T;
7.2.2.1) if P(T)−Eu(T)−Cn(T)<=Cn−1(T),
the steady-state storage module of the n−1^{th} information unit outputs data amount P(T)−Eu(T)−Cn(T) to the data output port;
the p^{th} deduction of the steady-state storage module of the n−1^{th} information unit is:
Qn−1(p)=P(T)−Eu(T)−Cn(T);
After the p^{th} deduction, remaining data amount of the steady-state storage module of the n−1^{th} information unit is:
Cn−1y(T)=Cn−1(T)−Qn−1(p);
the data amount received by the data output port is accumulated and stored;
subsequently, the control operation unit instructs the data output port of the user's information unit set to perform data amount output, and the output data amount is P(T);
the control operation unit opens SCn−1 of the user's n−1^{th} information unit;
the control operation unit closes the user's heartbeat line control switch SHB;
the control operation unit returns a success response message to the data output request of this time;
the operation of the data output request of this time ends up;
7.2.2.2) if P(T)−Eu(T)−Cn(T)>Cn−1(T),
the data amount in the steady-state storage module of the n−1^{th} information unit is totally output to the data output port;
the p^{th} deduction of the steady-state storage module of the n−1^{th} information unit is: Qn−1(p)=Cn−1(T);
after the p^{th} deduction, data amount of the steady-state storage module of the n−1^{th} information unit is:
Cn−1y(T)=Cn−1(T)−Cn−1(T)=0;
the data amount received by the data output port is accumulated and stored;
the control operation unit opens SCn−1 of the user's n−1^{th} information unit;
at any time t thereafter, t>Tn−1(p), the data amount of the steady-state storage module of the n−1^{th} information unit Cn−1(0=0;
the control operation unit executes 7.2.3);
similarly,
7.2.n-1) the control operation unit closes SC2 of the information unit created the second in the user's information unit set so that data in the steady-state storage module of the second information unit may be output;
the control operation unit adds 1 to the number of times of data output operations with respect to the steady-state storage module of the second information unit, wherein the number of times of data output operations with respect to the steady-state storage module of the second information unit is represented by r, and r=0, 1, 2, . . . natural number;
and, the control operation unit records time T2(r) of occurrence of the r^{th} deduction of the data amount of the steady-state storage module of the second information unit, T2(r)=T, wherein r=1, 2, 3, . . . , namely, the current time information T as stated in above step 2) is also system-recorded time of occurrence of the r^{th} output of the data amount of the steady-state storage module of the second information unit; wherein the time of creating the user's second information unit is represented by T2(0);
compare P(T)−Eu(T)−Cn(T)−Cn−1(T)− . . . −C3(T) with C2(T), and C2(T) is the data amount of the steady-state storage module of the second information unit of the user's information unit set at time T;
7.2.n-1.1) if P(T)−Eu(T)−Cn(T)−Cn−1(T)− . . . −C3 (T)<=C2(T),
the steady-state storage module of the second information unit outputs data amount P(T)−Eu(T)−Cn(T)−Cn−1(T)− . . . −C3 (T) to the data output port;
the r^{th} deduction of the steady-state storage module of the second information unit is:
Q2(r)=P(T)−Eu(T)−Cn(T)−Cn−1(T)− . . . −C3(T);
after the r^{th} deduction, remaining data amount of the steady-state storage module of the second information unit is:
C2y(T)=C2(T)−Q2(r);
the data amount received by the data output port is accumulated and stored;
subsequently, the control operation unit instructs the data output port of the user's information unit set to perform data amount output, and the output data amount is P(T);
the control operation unit opens SC2 of the user's second information unit;
the control operation unit closes the user's heartbeat line control switch SHB;
the control operation unit returns a success response message to the data output request of this time;
the operation of the data output request of this time ends up;
7.2.n-1.2) if P(T)−Eu(T)−Cn(T)−Cn−1(T)− . . . −C3 (T)>C2(T),
the data amount in the steady-state storage module of the second information unit is totally output to the data output port;
the r^{th} deduction of the steady-state storage module of the second information unit Q2(r)=C2(T);
after the r^{th} deduction, remaining data amount of the steady-state storage module of the second information unit is:
C2y(T)=C2(T)−C2(T)=0;
the control operation unit opens SC2 of the user's second information unit;
at any time t thereafter, t>T2(r), the data amount of the steady-state storage module of the second information unit C2(t)=0;
the control operation unit executes 7.2.n);
7.2.n) the control operation unit closes SC1 of the information unit created the first in the user's information unit set so that data in the steady-state storage module of the first information unit may be output;
the control operation unit adds 1 to the number of times of data output operations with respect to the steady-state storage module of the first information unit, wherein the number of times of data output operations with respect to the steady-state storage module of the first information unit is represented by z, and z=0, 1, 2, . . . natural number;
and, the control operation unit records time T1(z) of occurrence of the z^{th} deduction of the data amount of the steady-state storage module of the first information unit, T1(z)=T, wherein z=1, 2, 3, . . . , namely, the current time information T as stated in above step 2) is also system-recorded time of occurrence of the z^{th} output of the data amount of the steady-state storage module of the first information unit; wherein the time of creating the user's first information unit is represented by T1(0);
compare P(T)−Eu(T)−Cn(T)−Cn−1(T)− . . . −C3(T)−C2(T) with C1(T), and C1(T) is the data amount of the steady-state storage module of the first information unit of the user's information unit set at time T;
since Eu(T)<P(T)<Su(T)=Cu(T)+Eu(T),
P(T)−Eu(T)−Cn(T)−Cn−1(T)− . . . −C3(T)−C2(T)<C1(T)
then the data amount output by the steady-state storage module of the first information unit to the data output port is P(T)−Eu(T)−Cn(T)−Cn−1(T)− . . . −C3(T)−C2(T);
namely, the z^{th} deduction of the steady-state storage module of the first information unit is:
Q1(z)=P(T)−Eu(T)−Cn(T)−Cn−1(T)− . . . −C3(T)−C2(T);
after the z^{th} deduction, remaining data amount of the steady-state storage module of the first information unit is:
C1y(T)=C1(T)−Q1(z);
the data amount received by the data output port is accumulated and stored;
subsequently, the control operation unit instructs the data output port of the user's information unit set to perform data amount output, and the output data amount is P(T);
the control operation unit opens SC1 of the user's first information unit;
the control operation unit closes the user's heartbeat line control switch SHB;
the control operation unit returns a success response message to the data output request of this time;
the operation of the data output request of this time ends up.

11. The real-time processing method for an information unit set according to claim 10, wherein processing the data output request according to the comparison result in said step 5) specifically includes:
5.1) if P(T)>Su(T),
if the control operation unit rejects the data output request of this time,
the control operation unit closes the user's heartbeat line control switch SHB;
the control operation unit returns a failure response message to the data output request of this time, and its cause is insufficient sum of stored data;
the operation of the data output request of this time ends up;
or, if the control operation unit receives the data output request of this time, the control operation unit closes all SCns and SEns of all information units in the user's information unit set so that data in the dynamic storage module and steady-state storage module of each information unit is totally output to the data output port, namely, the data amount Cn(T) and En(T) at time T are totally cleared;
the data amount received by the data output port is accumulated and stored;
subsequently, the control operation unit instructs the data output port of the user's information unit set to perform data amount output, and the output data amount is Su(T);
the control operation unit adds 1 respectively to the record of the number of times of data output operations of each steady-state storage module and each dynamic storage module in the user's each information unit;
and the control operation unit records time of occurrence of data output operation of each steady-state storage module and each dynamic storage module in the user's each information unit;
the control operation unit opens all SCns and SEns of all information units in the user's information unit set;
the control operation unit closes the user's heartbeat line control switch SHB;
the control operation unit returns a success response message to the data output request of this time;
the operation of the data output request of this time ends up;
at any time t thereafter, t>T, the data amount of the steady-state storage module and dynamic storage module of each information unit created prior to the time T in the user's information unit set is totally cleared;
5.2) if P(T)=Su(T),
the control operation unit accepts the data output request of this time, and the control operation unit closes all SCns and SEns of all information units in the user's information unit set so that data in the dynamic storage module and steady-state storage module of each information unit is totally output to the data output port, namely, the data amount Cn(T) and En(T) at time T are totally cleared;
the data amount received by the data output port is accumulated and stored;
subsequently, the control operation unit instructs the data output port of the user's information unit set to perform data amount output, and the output data amount is Su(T);
the control operation unit adds 1 respectively to the record of the number of times of data output operations of each steady-state storage module and each dynamic storage module in the user's each information unit;
and the control operation unit records time of occurrence of data output operation of each steady-state storage module and each dynamic storage module in the user's each information unit;
the control operation unit opens all SCns and SEns of all information units in the user's information unit set;
the control operation unit closes the user's heartbeat line control switch SHB;
the control operation unit returns a success response message to the data output request of this time;
the operation of the data output request of this time ends up;
at any time t thereafter, t>T, the data amount of the steady-state storage module and dynamic storage module of each information unit created prior to the time T in the user's information unit set is totally cleared;
5.3) if P(T)<Su(T), the control operation unit accepts the data output request of this time and performs operation of step 6).

12. The real-time processing method for an information unit set according to claim 10, wherein processing the data output request according to the comparison result in said step 6) specifically includes:
6.1) If P(T)=Eu(T),
the control operation unit accepts the data output request of this time, and the control operation unit closes all SEns of all information units in the user's information unit set so that data in the dynamic storage module of each information unit is totally output to the data output port, namely, the data amount En(T) at time T is totally cleared;
the data amount received by the data output port is accumulated and stored;
subsequently, the control operation unit instructs the data output port of the user's information unit set to perform data amount output, and the output data amount is Eu(T);
the control operation unit adds 1 to the record of the number of times of data output operations of the dynamic storage module in the user's each information unit;
and the control operation unit records time of occurrence of data output operation of the dynamic storage module in the user's each information unit;
the control operation unit opens all SEns of all information units in the user's information unit set;
the control operation unit closes the user's heartbeat line control switch SHB;
the control operation unit returns a success response message to the data output request of this time;
the operation of the data output request of this time ends up;
at any time t after the time T and prior to the time T_{HBw1} of the user's information unit set receiving the heartbeat signal for the first time, t∈(T, T_{HBw1}), the data amount En(t) in the dynamic storage module of the user's each information unit is totally zero, and represented as En(t)=Eny(T)=0, wherein n=1, 2, . . . ;
after the time T and at the time T_{HBw1} of the user's information unit set receiving the heartbeat signal for the first time, the data amount in the dynamic storage module of the user's each information unit En(T_{HBw1})=δEn(T_{HBw1}), and n=1, 2, . . . ; wherein δEn(T_{HBw1}) is a new data amount generated by the association exciter of the user's n^{th} information unit at the time T_{HBw1},
6.2) if P(T)<Eu(T), the control operation unit accepts the data output request of this time and performs the following operations;
6.2.1) the control operation unit closes SEn of the information unit created at latest in the user's information unit set so that data in the dynamic storage module of the n^{th} information unit may be output;
the control operation unit adds 1 to the number of times of data output operations with respect to the dynamic storage module of the n^{th} information unit; wherein the number of times of data output operations with respect to the dynamic storage module of the n^{th} information unit is represented by w, and w=0, 1, 2, . . . natural number;
and, the control operation unit records time Tne(w) of occurrence of the w^{th} output of data amount of the dynamic storage module of the n^{th} information unit, Tne(w)=T, wherein w=1, 2, 3, . . . , namely, the current time information T as stated in step 2) in the preceding claim 9 is also system-recorded time of occurrence of the w^{th} output of the data amount of the dynamic storage module of the n^{th} information unit;
compare P(T) with En(T), and En(T) is the data amount of the dynamic storage module of the n^{th} information unit of the user's information unit set at time T;
6.2.1.1) if P(T)<=En(T),
the dynamic storage module of the n^{th} information unit outputs data amount P(T) to the data output port;
the amount of w^{th} output of the dynamic storage module of the n^{th} information unit is: Dn(w)=P(T);
after the w^{th} output, remaining data amount of the dynamic storage module of the n^{th} information unit is:
Eny(T)=En(T)−P(T);
the data amount received by the data output port is accumulated and stored;
subsequently, the control operation unit instructs the data output port of the user's information unit set to perform data amount output, and the output data amount is P(T);
the control operation unit opens SEn of the user's n^{th} information unit;
the control operation unit closes the user's heartbeat line control switch SHB;
the control operation unit returns a success response message to the data output request of this time;
the operation of the data output request of this time ends up;
thereafter, at any time t after the time T and prior to the time T_{HBw1} of the user's information unit set receiving the heartbeat signal for the first time, t∈(T, T_{HBw1}), the data amount En(t) in the dynamic storage module of the user's n^{th} information unit is: En(t)=Eny(T)=En(T)−P(T);
after the time T and at the time T_{HBw1} of the user's information unit set receiving the heartbeat signal for the first time, the data amount in the dynamic storage module of the user's n^{th} information unit is:
En(T_{HBw1})=Eny(T)+δEn(T_{HBw1})=En(T)−P(T)+δEn(T_{HBw1});
wherein δEn(T_{HBw1}) is a new data amount generated by the association exciter of the user's n^{th} information unit at the time T_{HBw1};
6.2.1.2) if P(T)>En(T),
the data amount in the dynamic storage module of the n^{th} information unit is totally output to the data output port;
the w^{th} deduction of the dynamic storage module of the n^{th} information unit is: Dn(w)=En(T);
after the w^{th} deduction, the remaining data amount of the dynamic storage module of the n^{th} information unit is:
Eny(T)=En(T)−En(T)=0;
the data amount received by the data output port is accumulated and stored;
the control operation unit opens SEn of the user's n^{th} information unit,
thereafter, at any time t after the time T and prior to the time T_{HBw1} of the user's information unit set receiving the heartbeat signal for the first time, t∈(T, T_{HBw1}), the data amount En(t) in the dynamic storage module of the user's n^{th} information unit is: En(t)=Eny(T)=0;
after the time T and at the time T_{HBw1} of the user's information unit set receiving the heartbeat signal for the first time, the data amount in the dynamic storage module of the user's n^{th} information unit is:
En(T_{HBw1})=Eny(T)+δEn(T_{HBw1})=δEn(T_{HBw1});
wherein δEn(T_{HBw1}) is a new data amount generated by the association exciter of the user's n^{th} information unit at the time T_{HBw1},
the control operation unit executes step 6.2.2);
6.2.2) the control operation unit closes SEn−1 of the information unit created the second latest in the user's information unit set so that data in the dynamic storage module of the n−1^{th} information unit may be output;
the control operation unit adds 1 to the number of times of data output operations with respect to the dynamic storage module of the n−1^{th} information unit; wherein the number of times of data output operations with respect to the dynamic storage module of the n−1^{th} information unit is represented by v, and v=0, 1, 2, . . . natural number;
and, the control operation unit records time Tₙ₋₁ₑ(v) of occurrence of the v^{th} output of the data amount of the dynamic storage module of the n−1^{th} information unit, Tₙ₋₁ₑ(v)=T, wherein v=1, 2, 3, . . . , namely, the current time information T as stated in step 2) recited in the preceding claim 9 is also system-recorded time of occurrence of the v^{th} output of the data amount of the dynamic storage module of the n−1^{th} information unit;
compare P(T)−En(T) with En−1(T), and En−1(T) is the data amount of the dynamic storage module of the n−1^{th} information unit of the user's information unit set at time T;
6.2.2.1) if P(T)−En(T)<=En−1(T),
the dynamic storage module of the n−1^{th} information unit outputs data amount P(T)−En(T) to the data output port;
the v^{th} deduction of the dynamic storage module of the n−1^{th} information unit is: Dn−1(v)=P(T)−En(T);
after the v^{th} deduction, remaining data amount of the dynamic storage module of the n−1^{th} information unit is:
En−1y(T)=En−1(T)−Dn−1(v);
the data amount received by the data output port is accumulated and stored;
subsequently, the control operation unit instructs the data output port of the user's information unit set to perform data amount output, and the output data amount is P(T);
the control operation unit opens SEn−1 of the user's n−1^{th} information unit;
the control operation unit closes the user's heartbeat line control switch SHB;
the control operation unit returns a success response message to the data output request of this time;
the operation of the data output request of this time ends up;
thereafter, at any time t after the time T and prior to the time T_{HBw1} of the user's information unit set receiving the heartbeat signal for the first time, t∈(T, T_{HBw1}), the data amount En(t) in the dynamic storage module of the user's n−1^{th} information unit is:
En−1(t)=En−1y(T)=En(T)+En−1(T)−P(T);
after the time T and at the time T_{HBw1} of the user's information unit set receiving the heartbeat signal for the first time, the data amount in the dynamic storage module of the user's n−1^{th} information unit is:
En−1(T_{HBw1})=En−1y(T)+δEn−1(T_{HBw1})=En(T)+En−1(T)−P(T)+δEn−1(T_{HBw1});
wherein δEn−1(T_{HBw1}) is a new data amount generated by the association exciter of the user's n−1^{th} information unit at the time T_{HBw1};
6.2.2.2) if P(T)−En(T)>En−1(T),
the data amount in the dynamic storage module of the n−1^{th} information unit is totally output to the data output port;
the v^{th} deduction of the dynamic storage module of the n−1^{th} information unit is: Dn−1(v)=En−1(T);
after the v^{th} deduction, data amount of the dynamic storage module of the n−1th unit is:
En−1y(T)=En−1(T)−En−1(T)=0;
the data amount received by the data output port is accumulated and stored;
the control operation unit opens SEn−1 of the user's n−1^{th} information unit;
thereafter, at any time t after the time T and prior to the time T_{HBw1} of the user's information unit set receiving the heartbeat signal for the first time, t∈(T, T_{HBw1}), the data amount En−1(t) in the dynamic storage module of the user's n−1^{th} information unit is: En−1(t)=En−1y(T)=0;
after the time T and at the time T_{HBw1} of the user's information unit set receiving the heartbeat signal for the first time, the data amount in the dynamic storage module of the user's n−1^{th} information unit is:
En−1(T_{HBw1})=En−1y(T)+δEn−1(T_{HBw1})=δEn−1(T_{HBw1});
wherein δEn−1(T_{HBw1}) is a new data amount generated by the association exciter of the user's n−1^{th} information unit at the time T_{HBw1};
the control operation unit executes step 6.2.3);
similarly,
6.2.n-1) the control operation unit closes SE2 of the information unit created the second in the user's information unit set so that data in the dynamic storage module of the second information unit may be output;
the control operation unit adds 1 to the number of times of data output operations with respect to the dynamic storage module of the second information unit;
wherein the number of times of data output operations with respect to the dynamic storage module of the second information unit is represented by r, and r=0, 1, 2, . . . natural number;
and, the control operation unit records time T2e(r) of occurrence of the r^{th} output of the data amount of the dynamic storage module of the second information unit, T2e(r)=T, wherein r=1, 2, 3, . . . , namely, the current time information T as stated in step 2) in the preceding claim 9 is also system-recorded time of occurrence of the r^{th} output of the data amount of the dynamic storage module of the second information unit;
compare P(T)−En(T)−En−1(T)− . . . −E3(T) with E2(T), and E2(T) is the data amount of the dynamic storage module of the second information unit of the user's information unit set at time T;
6.2.n-1.1) if P(T)−En(T)−En−1(T)− . . . −E3(T)<=E2(T),
the dynamic storage module of the second information unit outputs data amount P(T)−En(T)−En−1(T)− . . . −E3(T) to the data output port;
the r^{th} deduction of the dynamic storage module of the second information unit is:
D2(r)=P(T)−En(T)−En−1(T)− . . . −E3(T);
after the r^{th} deduction, remaining data amount of the dynamic storage module of the second information unit is:
E2y(T)=E2(T)−D2(r);
the data amount received by the data output port is accumulated and stored;
subsequently, the control operation unit instructs the data output port of the user's information unit set to perform data amount output, and the output data amount is P(T);
the control operation unit opens SE2 of the user's second information unit;
the control operation unit closes the user's heartbeat line control switch SHB;
the control operation unit returns a success response message to the data output request of this time;
thereafter, at any time t after the time T and prior to the time T_{HBw1} of the user's information unit set receiving the heartbeat signal for the first time, t∈(T, T_{HBw1}), the data amount E2(t) in the dynamic storage module of the user's second information unit is:
E2(t)=E2y(T)=En(T)+En−1(T)+ . . . +E2(T)−P(T);
after the time T and at the time T_{HBw1} of the user's information unit set receiving the heartbeat signal for the first time, the data amount in the dynamic storage module of the user's second information unit is:
E2(T_{HBw1})=E2y(T)+δE2(T_{HBw1})=En(T)+En−1(T)+ . . . +E2(T)−P(T)+δE2(T_{HBw1});
wherein δEn2(T_{HBw1}) is a new data amount generated by the association exciter of the user's second information unit at the time T_{HBw1};
the operation of the data output request of this time ends up;
6.2.n-1.2) if P(T)−En(T)−En−1(T)− . . . −E3(T)>E2(T),
the data amount in the dynamic storage module of the second information unit is totally output to the data output port;
the r^{th} deduction D2(r)=E2(T);
after the r^{th} deduction, remaining data amount of the dynamic storage module of the second information unit is:
E2y(T)=E2(T)−E2(T)=0;
the data amount received by the data output port is accumulated and stored;
the control operation unit opens SE2 of the user's second information unit;
thereafter, at any time t after the time T and prior to the time T_{HBw1} of the user's information unit set receiving the heartbeat signal for the first time, t∈(T, T_{HBw1}), the data amount E2(t) in the dynamic storage module of the user's second information unit is: E2(t)=E2y(T)=0;
after the time T and at the time T_{HBw1} of the user's information unit set receiving the heartbeat signal for the first time, the data amount in the dynamic storage module of the user's second information unit is:
E2(T_{HBw1})=E2y(T)+δE2(T_{HBw1})=δE2(T_{HBw1});
wherein δEn2(T_{HBw1}) is a new data amount generated by the association exciter of the user's second information unit at the time T_{HBw1};
the control operation unit executes step 6.2.n);
6.2.n) the control operation unit closes SE1 of the information unit created the first in the user's information unit set so that data in the dynamic storage module of the first information unit may be output;
the control operation unit adds 1 to the number of times of data output operations with respect to the dynamic storage module of the first information unit;
wherein the number of times of data output operations with respect to the dynamic storage module of the first information unit is represented by z, and z=0, 1, 2, . . . natural number;
and, the control operation unit records time T1e(z) of occurrence of the z^{th} output of the data amount of the dynamic storage module of the first information unit, T1e(z)=T, wherein z=1, 2, 3, . . . , namely, the current time information T as stated in step 2) in the preceding claim 9 is also system-recorded time of occurrence of the z^{th} output of the data amount of the dynamic storage module of the first information unit;
compare P(T)−En(T)−En−1(T)− . . . −E3(T)−E2(T) with E1(T), and E1(T) is the data amount of the dynamic storage module of the first information unit of the user's information unit set at time T;
since P(T)<Eu(T)=E1(T)+E2(T . . . )+En(T), P(T)−En(T)−En−1(T)− . . . −E3(T)−E2(T)<E1(T)
then the data amount output by the dynamic storage module of the first information unit to the data output port:
P(T)−En(T)−En−1(T)− . . . −E3(T)−E2(T);
namely, the z^{th} deduction of the dynamic storage module of the first information unit is:
D1(z)=P(T)−En(T)−En−1(T)− . . . −E3(T)−E2(T);
after the z^{th} deduction, remaining data amount of the dynamic storage module of the first information unit is:
E1y(T)=E1(T)−D1(z);
the data amount received by the data output port is accumulated and stored;
subsequently, the control operation unit instructs the data output port of the user's information unit set to perform data amount output, and the output data amount is P(T);
the control operation unit opens SE1 of the user's first information unit;
the control operation unit closes the user's heartbeat line control switch SHB;
the control operation unit returns a success response message to the data output request of this time;
the operation of the data output request of this time ends up;
thereafter, at any time t after the time T and prior to the time T_{HBw1} of the user's information unit set receiving the heartbeat signal for the first time, t∈(T, T_{HBw1}), the data amount E1(t) in the dynamic storage module of the user's first information unit is:
E1(t)=E1y(T)=En(T)+En−1(T)+ . . . +E2(T)+E1(T)−P(T);
after the time T and at the time T_{HBw1} of the user's information unit set receiving the heartbeat signal for the first time, the data amount in the dynamic storage module of the user's first information unit is:
E1(T_{HBw1})=E1y(T)+δE1(T_{HBw1})=En(T)+En−1(T)+ . . . +E2(T)+E1(T)−P(T)+δE1(T_{HBw1});
wherein δE1(T_{HBw1}) is a new data amount generated by the association exciter of the user's first information unit at the time T_{HBw1};
6.3) if P(T)>Eu(T), the control operation unit executes operation of step 7).

13. The real-time processing method for an information unit set according to claim 10, wherein after said step (7.2.1.1), at any time t before next deduction of the steady-state storage module of the n^{th} information unit, namely, before occurrence of the m+1^{th} deduction, t∈(Tn(m), Tn(m+1)), the data amount Cn(t) of the steady-state storage module of the n^{th} information unit is:
Cn(t)=Cny(T)=Cn(T)−Qn(m)=Eu(T)+Cn(T)−P(T);
after said step 7.2.1.2), at any time t, t>Tn(m), the data amount of the steady-state storage module of the n^{th} information unit Cn(t)=0; after said step 7.2.2.1), at any time t before occurrence of deduction of next time, namely of the ±p+1^{th} time, t∈(Tn−1(p), Tn−1(p+1)), the data amount Cn−1(t) of the steady-state storage module of the n−1^{th} information unit is:
Cn−1(t)=Cn−1y(T)=Cn−1(T)−Qn−1(p)=Eu(T)+Cn(T)+Cn−1(T)−P(T);
after said step 7.2.n-1.1), at any time t before occurrence of deduction of next time, namely of the r+1^{th} time, t (T2(r), T2(r+1)), the data amount C2(t) of the steady-state storage module of the second information unit is:
C2(t)=C2y(T)=C2(T)−Q2(r)=Eu(T)+Cn(T)+Cn−1(T)+ . . . +C3(T)+C2(T)−P(T);
after said step 7.2.n), at any time t before occurrence of deduction of next time, namely of the z+1^{th} time, t∈(T1(z), T1(z+1)), the data amount C1(t) of the steady-state storage module of the first information unit is:
C1(t)=C1y(T)=C1(T)−Q1(z)=Eu(T)+Cn(T)+Cn−1(T)+ . . . +C3(T)+C2(T)+C1(T)−P(T).

14. The real-time processing method for an information unit set according to claim 10, wherein after the control operation unit opens the user's heartbeat line control switch SHB in said step 3), during a time period from the time T when the control operation unit opens the user's heartbeat line control switch SHB to time tc when the control operation unit closes the user's heartbeat line control switch SHB again, if the control operation unit receives a data output request with respect to the user's information unit set, the method further comprises the following steps:
if the control operation unit rejects the data output request of this time, it returns a failure response message to the data output request of this time, and its cause is that the system is busy; the operation of the data output request of this time ends up;
or, if the control operation unit accepts the data output request of this time, the control operation unit delays the time of data output operation of the data output request of this time so that time T_{b2} of occurrence of the data output operation of the user's information unit set this time by the control operation unit is T_{b2}=tc+δT or T_{b2}>tc+δT.

15. The real-time processing method for an information unit set according to claim 10, wherein after the control operation unit opens the user's heartbeat line control switch SHB in said step 3), the method further comprises the following steps:
during a time period from the time T when the control operation unit opens the user's heartbeat line control switch SHB to time tc when the control operation unit closes the user's heartbeat line control switch SHB again, the heartbeat count register in the information unit set records the number h of the received heartbeat signals, and h=0, 1, 2, . . . ;
at the time when the first heartbeat signal comes after the heartbeat line control switch SHB closes again, namely, at the time when the h+1^{th} heartbeat signal comes after the control switch SHB closes, a heartbeat number field value in the heartbeat signal sent from the heartbeat count register is h+1, wherein h=0, 1, 2, . . . .

16. The real-time processing method for an information unit set according to claim 10, wherein after the control operation unit opens the user's heartbeat line control switch SHB in said step 3), during a time period from the time T when the control operation unit opens the user's heartbeat line control switch SHB to time tc when the control operation unit closes the user's heartbeat line control switch SHB again, if the control operation unit receives a data input request with respect to the user's information unit set, the method further comprises the following steps:
if the control operation unit rejects the data input request of this time, it returns a failure response message to the data input request of this time, and its cause is that the system is busy; the operation of the data input request of this time ends up;
or, if the control operation unit accepts the data input request of this time, the control operation unit delays the time of data input operation of the data input request of this time so that time Tᵢ₂ of occurrence of the data input operation of the user's information unit set this time by the control operation unit is tc+δT>Ti2>tc or Ti2=tc+δT.
